(19) United States
(12) Patent Application Publication
(10) Pub. No.: US 2026/0037084 A1
(43) Pub. Date: Feb. 5, 2026

(54) ANTIFOULING MEMBER, AND DISPLAY, TOUCH PANEL AND SENSOR EACH USING SAME, AND METHOD FOR PRODUCING ANTIFOULING MEMBER

(71) Applicant: DAIKIN INDUSTRIES, LTD., Osaka (JP)

(72) Inventors: Kyohei MOCHIZUKI, Tokyo (JP); Masanori Kimura, Tokyo (JP); Shinji Kida, Tokyo (JP); Hisashi Mitsuhashi, Osaka-shi (JP); Takeshi Maehira, Osaka-shi (JP); Kaori Ozawa, Osaka (JP)

(73) Assignees: DAIKIN INDUSTRIES, LTD., Osaka (JP); MOMENTIVE PERFORMANCE MATERIALS JAPAN LLC, Tokyo (JP)

(21) Appl. No.: 19/250,763

(22) Filed: Jun. 26, 2025

Related U.S. Application Data
(63) Continuation of application No. PCT/JP2023/046941, filed on Dec. 27, 2023.

(30) Foreign Application Priority Data
Dec. 28, 2022 (JP) 2022-211198

(51) Int. Cl. G06F 3/041

(52) U.S. Cl. CPC G06F 3/0412

(57) ABSTRACT

According to a first aspect of the present invention, there is provided an antifouling member, in which a surface of one face is provided with irregularities on an order of nanometers, the antifouling member including an antifouling layer which is provided on recesses of the irregularities. In addition, there are also provided a display in which at least a part of a display portion is covered with the antifouling member, a touch panel in which at least a part of a touch portion is covered with the antifouling member, and a sensor in which at least a partial surface is covered with the antifouling member.

### CROSS REFERENCE TO RELATED APPLICATIONS

This application is a Rule 53(b) Continuation of International Application No. PCT/JP2023/046941 filed Dec. 27, 2023, claiming priority based on Japanese Patent Application No. 2022-211198 filed Dec. 28, 2022, the disclosures of which are incorporated herein by reference in their respective entireties BACKGROUND

### 1. TECHNICAL FIELD

The present invention relates to an antifouling member, and a display, a touch panel, and a sensor using the same, and a manufacturing method of the antifouling member.

### 2. RELATED ART

It is known that water/oil repellency and antifouling property are imparted to a base material by using a fluorine-based compound for surface treatment of the base material (for example, Patent Documents 1 and 2).
Patent Document 1: Japanese Patent Application Publication No. 2014-218639
Patent Document 2: Japanese Patent Application Publication No. 2017-082194

A first aspect of the present invention provides an antifouling member having an antifouling layer. A surface of one face of the antifouling member may be provided with irregularities on an order of nanometers. The antifouling layer may be provided on recesses of the irregularities.

In the above, an average pitch width of protrusions of the irregularities may be 5 to 18 nm.

In the above, a surface roughness (Rz) measured on a plane of the irregularities may be 9 to 12 nm.

In the above, a surface roughness (Rz) measured in a cross section of the irregularities may be 3 to 5 nm.

In the above, a maximum height difference (P−V) measured on a plane of the irregularities may be 5 to 15 nm.

In the above, a maximum height difference (P−V) measured in a cross section of the irregularities may be 4 to 8 nm.

In the above, an arithmetic average roughness (Ra) measured on a plane of the irregularities may be 0.6 to 2.0 nm.

In the above, an arithmetic average roughness (Ra) measured in a cross section of the irregularities may be 0.6 to 2.0 nm.

In the above, a root mean square roughness (RMS) measured on a plane of the irregularities may be 0.8 to 2.0 nm.

In the above, a root mean square roughness (RMS) measured in a cross section of the irregularities may be 0.7 to 3.0 nm.

In the above, the antifouling member may include a base material; and an irregularity forming layer, and the irregularities may be formed on a surface of the irregularity forming layer.

In the above, the antifouling member may include a base material, and the irregularities may be formed on a surface of the base material.

In the above, a height, in a normal direction of the one face, of the antifouling layer formed in the recesses may not exceed that of protrusions of the irregularities.

In the above, a contact angle when water comes into contact with a side of the one face of the antifouling member may be 105 to 120°.

In the above, a pencil hardness on a side of the one face of the antifouling member may be HB or more.

In the above, the antifouling layer may contain a perfluoropolyether-containing silane compound.

In the above, the irregularity forming layer may contain a silicone resin.

In the above, the silicone resin may include a Q unit structure and a T unit structure.

In the above, a composition ratio of carbon atoms in recesses of the irregularity forming layer may be larger than that in protrusions thereof.

In the above, a molar concentration of a silanol group in recesses of the irregularity forming layer may be higher than that in protrusions thereof.

In a second aspect of the present invention, there is provided a display in which at least a part of a display portion is covered with the antifouling member.

In a third aspect of the present invention, there is provided a touch panel in which at least a part of a touch portion is covered with the antifouling member.

In a fourth aspect of the present invention, there is provided sensor in which at least a partial surface is covered with the antifouling member.

Note that, the summary clause does not necessarily describe all necessary features of the embodiments of the present invention. In addition, the present invention may also be a sub-combination of the features described above.

### BRIEF DESCRIPTION OF THE DRAWINGS

FIG. 1 illustrates an example of an antifouling member 10 in the present embodiment.

FIG. 2 illustrates another example of the antifouling member 10 in the present embodiment.

FIG. 3 illustrates an example of a flow of a manufacturing method of the antifouling member 10 of the present embodiment.

FIG. 4 illustrates an example of S100 of the flow of FIG. 3 when an irregularity forming layer 120 is provided.

### DESCRIPTION OF EXEMPLARY EMBODIMENTS

Hereinafter, the present invention will be described through embodiments of the invention. However, the following embodiments do not limit the invention defined in the claims. In addition, not all combination of the features described in the embodiments are necessary for the solution of the invention.

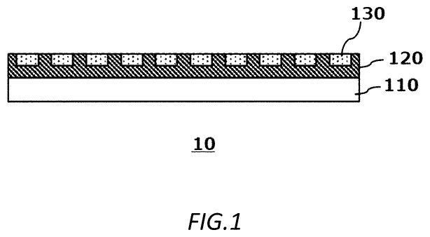

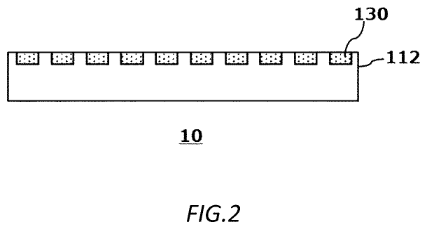

FIGS. 1 and 2 illustrate an example of an antifouling member 10 in the present embodiment. The antifouling member 10 is a surface protection member to which adhering substances such as dirt are less likely to adhere and from which adhering substances that have adhered are easily removed. The antifouling member 10 is applied to a product (an automobile, a mobile terminal such as a smartphone, an optical product such as a camera, a measuring instrument such as a sensor, other machine, an electrical product, or the like) or a component for which adhesion of dirt (for example, dust, pollen, fingerprint, oil, or the like) is not preferable. For example, the antifouling member 10 is used to cover at least a part of a display portion of a display, to cover at least a part of a touch portion of a touch panel, or to cover at least a partial surface of a sensor. In the antifouling member 10, irregularities on an order of nanometers are provided on a surface of one face, and an antifouling layer 130 provided on recesses of the irregularities is provided.

In FIG. 1, the antifouling member 10 includes a base material 110, an irregularity forming layer 120, and the antifouling layer 130, and irregularities on the order of nanometers are provided on a surface of the irregularity forming layer 120.

The base material 110 has a role of supporting the irregularities and the antifouling layer 130 provided on the antifouling member 10. The base material 110 can be selected from various materials according to a purpose of using the antifouling member 10. For example, the base material 110 may be formed from any material, such as glass, resin, metal, ceramics, semiconductor, fiber material, fur, leather, wood, porcelain, or stone. When the antifouling member 10 is provided on an optical product such as a display or a touch panel or a component thereof, the base material 110 may be formed from a transparent material such as glass or resin. The base material 110 may have any shape as long as it has a place where irregularities can be provided, and may have, for example, a plate shape.

The irregularity forming layer 120 is a layer which is provided on one face of the base material 110 and holds the antifouling layer 130 by irregularities. The irregularity forming layer 120 may further function as a hard coat layer which imparts abrasion resistance to the antifouling member 10. The irregularity forming layer 120 may be a material having abrasion resistance, and may be formed from, for example, an inorganic material such as silica or a metal oxide, or a relatively hard organic material such as a silicone resin, an acrylic resin, a melamine resin, or a urethane resin.

In the example of FIG. 1, irregularities are provided in the irregularity forming layer 120. Since the irregularities are provided in the irregularity forming layer 120 which is a lower layer of the antifouling layer 130, the antifouling layer 130 is surrounded and protected by protrusions, and the antifouling layer 130 fits into recesses, so that the antifouling layer 130 is firmly joined to the irregularity forming layer 120. Conventionally, an antifouling layer on a surface of an antifouling member may be worn by friction such as wiping of dirt or use for a long period of time, and an antifouling performance may not be maintained. On the other hand, according to the antifouling member 10 of the present embodiment, since the antifouling layer 130 is more firmly held by the irregularities, the antifouling performance can be maintained for a longer period of time. Further, since the irregularities are on the order of nanometers, transparency of the antifouling member 10 can also be secured.

As an example, the irregularity forming layer 120 may be composed of a silicone resin having irregularities. The silicone resin may include a Q unit structure and a T unit structure. The recesses of the irregularities may include more T unit structures than the protrusions of the irregularities. At least partially, an active silanol group (Si—OH) may be exposed on surfaces of the protrusions and the recesses (particularly, the surface of the recesses). Accordingly, it is possible to further strengthen bonding with the antifouling layer 130. A method for forming the irregularities of the silicone resin will be described later.

Various shapes can be adopted for a cross section of the protrusions of the irregularities. For example, the cross section of the protrusions may be a shape which has a rectangular tip, a shape which has a tapered or inversely tapered tip, a shape which has a pointed tip, a shape which has a tip with a curved surface such as a hemisphere, or the like.

An average pitch width (average peak-to-peak length) of the protrusions of the irregularities may be 5 to 18 nm, and preferably 7 to 15 nm. When the average pitch width is equal to or less than a predetermined size, the transparency of the antifouling member 10 can be secured. In addition, when the average pitch width is equal to or more than the predetermined size, the antifouling layer 130 can be more firmly held. In particular, when the average pitch width falls within a certain range, the irregularities of the irregularity forming layer and the antifouling layer 130 are more firmly connected by an anchor effect, and a holding force of the antifouling layer 130 can be enhanced. The average pitch width may be a numerical value measured at one specific cross section or plane in an atomic force microscope or the like.

A surface roughness (Rz) measured on a plane of the irregularities may be 1 to 15 nm, and preferably 9 to 12 nm. A surface roughness (Rz) measured in the cross section of the irregularities may be 1 to 10 nm, and preferably 3 to 5 nm or more. When the surface roughness (Rz) is equal to or less than a predetermined size, the transparency of the antifouling member 10 can be secured. In addition, when the surface roughness (Rz) is equal to or more than the predetermined size, the antifouling layer 130 can be more firmly held. In particular, when the surface roughness (Rz) falls within a certain range, the irregularities of the irregularity forming layer and the antifouling layer 130 are more firmly connected by the anchor effect, and the holding force of the antifouling layer 130 can be enhanced.

An arithmetic average roughness (Ra) measured on the plane of the irregularities may be 0.6 to 2.0 nm or more, and preferably 0.8 to 1.0 nm. An arithmetic average roughness (Ra) measured in the cross section of the irregularities may be 0.6 to 2.0 nm, and preferably 0.8 to 1.0 nm. When the arithmetic average roughness (Ra) is equal to or less than a predetermined size, the transparency of the antifouling member 10 can be secured. In addition, when the arithmetic average roughness (Ra) is equal to or more than the predetermined size, the antifouling layer 130 can be more firmly held. In particular, when the arithmetic average roughness (Ra) falls within a certain range, the irregularities of the irregularity forming layer and the antifouling layer 130 are more firmly connected by the anchor effect, and the holding force of the antifouling layer 130 can be enhanced.

A root mean square roughness (RMS) measured on the plane of the irregularities may be 0.8 to 2.0 nm, and preferably 0.9 to 1.5 nm. A root mean square roughness (RMS) measured in the cross section of the irregularities may be 0.7 to 3.0 nm, and preferably 0.9 to 1.5 nm. When the root mean square roughness (RMS) is equal to or less than a predetermined value, the transparency of the antifouling member 10 can be secured. In addition, when the root mean square roughness (RMS) is equal to or more than the predetermined value, the antifouling layer 130 can be more firmly held. In particular, when the root mean square roughness (RMS) falls within a certain range, the irregularities of the irregularity forming layer and the antifouling layer 130 are more firmly connected by the anchor effect, and the holding force of the antifouling layer 130 can be enhanced.

A maximum height difference (P−V) measured on the plane of the irregularities may be 5 to 15 nm, and preferably 8 to 12 nm. A maximum height difference (P−V) measured in the cross section of the irregularities may be 4 to 8 nm, and preferably 3 to 7 nm. When the maximum height difference (P−V) is equal to or less than a predetermined size, the transparency of the antifouling member 10 can be secured. In addition, when the maximum height difference (P−V) is equal to or more than the predetermined size, the antifouling layer 130 can be more firmly held. In particular, when the maximum height difference (P−V) falls within a certain range, the irregularities of the irregularity forming layer and the antifouling layer 130 are more firmly connected by the anchor effect, and the holding force of the antifouling layer 130 can be enhanced.

The antifouling layer 130 is formed on a side of the irregularity forming layer 120 opposite to the base material 110 (that is, an outermost surface of the antifouling member 10), and prevents adhering substances such as dirt from adhering to a surface of the antifouling member 10. The antifouling layer 130 may be formed in at least the recesses of the irregularities of the irregularity forming layer 120. For example, as illustrated in FIG. 1, the antifouling layer 130 may be formed only in the recesses.

Alternatively, the antifouling layer 130 may be formed not only in the recesses but also on the protrusions. In this case, there is a possibility that a part or a whole of the antifouling layer 130 on the protrusions is peeled off by transportation and use of a product, wiping off adhering substances, or the like. Even in such a case, the recess portion firmly holds the antifouling layer 130. Therefore, the antifouling member 10 can maintain the antifouling performance.

It is sufficient if the antifouling layer 130 is provided at least on a bottom surface of the recesses and/or an upper surface of the protrusions. The antifouling layer 130 may be provided, or may not be provided at all, on a whole or a part of a side surface portion of the recesses and/or the protrusions.

A height, in a normal direction of the one face (a vertical direction in FIG. 1), of the antifouling layer 130 formed in the recesses of the irregularity forming layer 120 may not exceed that of the protrusions of the irregularities of the irregularity forming layer 120. For example, it is desirable that, in at least about 50% of the recesses, the height of the antifouling layer 130 in the recesses does not exceed that of the protrusions. In the example of FIG. 1, the height, in the normal direction of the one face, of the antifouling layer 130 formed in the recesses is the same as the height of the protrusions of the irregularity forming layer 120 (that is, flush with the upper surface of the protrusions). In addition, a thickness of the antifouling layer 130 on the recesses is preferably 1 to 10 nm.

A surface portion of the antifouling layer 130 exhibits the antifouling performance, but if a film thickness of the antifouling layer 130 in the recesses is excessively thick, it may cause haze (cloudiness) of the antifouling member. As described above, since the film thickness of the antifouling layer 130 in the recesses is not excessively thick, haze (cloudiness) of the antifouling member can be prevented. Note that since a thick film portion of the antifouling layer 130 on the protrusions is relatively easily worn by wiping or the like, a problem of haze (cloudiness) hardly occurs.

The antifouling layer 130 may be formed from a material having oil repellency and/or water repellency. For example, the antifouling layer 130 may contain a fluorine-containing silane compound. Examples of the fluorine-containing silane compound include a perfluoropolyether-containing silane compound, a perfluoroalkyl group-containing silane compound, an isocyanuric skeleton-containing silane compound, or the like. Details of the material of the antifouling layer 130 will be described later.

The antifouling member 10 may have a contact angle of 105 to 120° when water comes into contact with one face side (for example, the antifouling layer 130 side). Accordingly, the antifouling member 10 exhibits water repellency and can exhibit antifouling performance. Furthermore, the antifouling member 10 may have a contact angle of 90° or more after abrasion test 1 and/or abrasion test 2 described later. Accordingly, the antifouling member 10 can exhibit the antifouling performance for a long time.

A pencil hardness of the one face side (for example, the antifouling layer 130 side) of the antifouling member 10 may be HB or more. Accordingly, the antifouling member 10 can possess abrasion resistance sufficient for holding the antifouling layer 130 for a longer period of time.

The antifouling member 10 may have, on the one face side (for example, the antifouling layer 130 side), a ΔHaze of 5 or less in a Taber abrasion test based on an ASTM D1044 standard. Accordingly, the antifouling member 10 can hold the antifouling layer 130 for a longer period of time and can possess abrasion resistance sufficient for maintaining the transparency.

In the embodiment of FIG. 2, the antifouling member 10 includes the base material 110 and the antifouling layer 130. In FIG. 2, the irregularity forming layer 120 is not present, and irregularities are provided on the surface of the base material 110. Accordingly, the base material 110 and the antifouling layer 130 are in direct contact with each other. Also in the embodiment of FIG. 2, since the antifouling layer 130 is firmly held by the irregularities, a same effect as that of the embodiment of FIG. 1 can be obtained. Matters described in FIG. 1 such as the materials and shapes of the base material 110 and the antifouling layer 130, and the size, contact angle, or hardness of the irregularities are also applied to the embodiment of FIG. 2, and thus the description thereof is omitted.

In the examples of FIGS. 1 and 2, examples have been described in which the antifouling member 10 includes the base material 110 and the antifouling layer 130 (the irregularity forming layer 120 in FIG. 1), but another layer may be further provided. For example, the antifouling member 10 may be provided with a layer such as a primer layer, an antireflection layer, an antiglare layer, an insulating layer, an adhesive layer, a release layer, a polarizing layer, and/or a retardation layer as necessary.

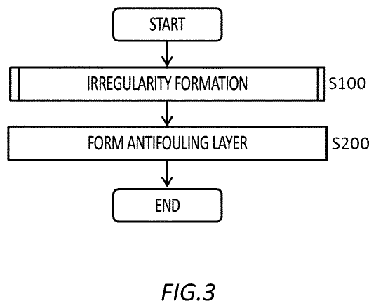

FIG. 3 illustrates an example of a flow of a manufacturing method of the antifouling member 10 of the present embodiment. The antifouling member 10 may be manufactured by executing at least a part of S100 to S200.

In S100, irregularities on the order of nanometers are provided on a surface of the base material 110. The base material 110 may be the one described in FIGS. 1 and 2. For example, irregularities may be formed on the base material 110 by providing, on the base material 110, the irregularity forming layer 120 provided with irregularities on the order of nanometers.

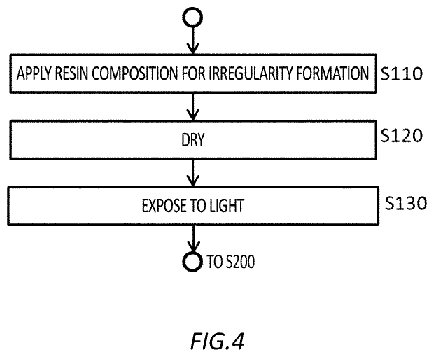

FIG. 4 illustrates an example of S100 of the flow of FIG. 3 when the irregularity forming layer 120 is provided. S100 in FIG. 3 may be executed by performing S110 to S130 in FIG. 4.

In S110, a resin composition for irregularity formation is applied onto the base material 110. The resin composition for irregularity formation may be an organosiloxane-based hard coat agent having the T unit structure and the Q unit structure.

The Q unit structure may be contained in the resin composition for irregularity formation as silica gel particles (colloidal silica). The silica gel particles impart a shape of protrusions of irregularities later, and may have a diameter of preferably 1 to 100 nm, preferably 10 to 50 nm, and more preferably 10 to 20 nm. Here, the diameter may be a median diameter D50 which is a particle diameter at which a cumulative volume is 50 vol % when a volume-based particle size distribution is measured by a laser diffraction/scattering particle size distribution measuring method.

The T unit structure may be contained in the resin composition for irregularity formation as an organosilsesquioxane polymer. The Q unit structure may be uniformly dispersed in a matrix of the T unit structure. The Q unit structure may be contained in an amount of 5 to 50 wt %, preferably 15 to 35 wt %, with respect to a sum of the T unit structure and the Q unit structure.

For example, in the resin composition for irregularity formation, the resin composition for irregularity formation containing the T unit structure and the Q unit structure can be obtained by hydrolyzing colloidal silica and an alkyl trialkoxysilane (as an example, methyltrimethoxysilane) and then condensing them.

A skeleton having an ultraviolet absorbing function may be at least partially incorporated in the T unit structure and/or the Q unit structure. Examples of the skeleton having an ultraviolet absorbing function can include 4,6-dibenzoyl-2-(3-trialkoxysilylalkyl)resorcinol (specifically, 4,6-dibenzoyl-2-(3-triethoxysilylpropyl)resorcinol or the like) described in Japanese Patent Application Publication No. H7-278525, hydroxybenzophenone-based compounds described in Japanese Patent Application Publication No. S57-21476 and Japanese Patent Application Publication No. S57-21432, or the like. As an example of the resin composition for irregularity formation, hard coats AS4700, AS4700F, PHC587C, and PHC587C2 manufactured by Momentive Performance Materials Inc. or the like can be used.

As an application method, application may be performed by various coating methods such as dip coating, spin coating, flow coating, spray coating, roll coating, and gravure coating, or printing methods such as letterpress printing, gravure printing, lithographic printing, reverse printing, and inkjet printing.

A film thickness to which the resin composition for irregularity formation is applied may be 1 to 20 μm, and preferably 3 to 10 μm.

Note that in S110, a primer composition for enhancing adhesion between the base material 110 and the resin composition for irregularity formation may be applied to the base material 110 before the application of the resin composition for irregularity formation. For example, the primer composition may be an acrylic resin composition, a polyester resin composition, a polyurethane resin composition, an epoxy resin composition, a melamine resin composition, a polyolefin resin composition, or a urethane acrylate resin composition.

Next, in S120, the resin composition for irregularity formation applied in S110 is dried. For example, thermal curing may be performed at a temperature of 100 to 150° C., preferably 120 to 130° C., for a time of 10 to 120 minutes, preferably 30 to 60 minutes. The drying may be performed by a hot air drying furnace, a hot plate, an infrared heater, or the like.

Next, in S130, irregularities are formed on the resin composition for irregularity formation that has been dried. For example, the irregularities are formed by exposing the resin composition for irregularity formation to light. This is because the T unit structure of the resin composition for irregularity formation is converted into silica (SiO₂) by exposure to cause volume shrinkage. Specifically, ozone and active oxygen radicals are generated from oxygen in an atmosphere by irradiation with UV light, and these react with a Si-alkyl group contained in the T unit structure. As a result, the Si-alkyl group contained in the T unit structure is decomposed into a silanol group and an aldehyde, and two silanol groups are further condensed to form silica (SiO₂). The aldehyde is further decomposed into water and CO₂. As described above, when the T unit structure is converted to silica (SiO₂), volume shrinkage occurs, and a place where the volume shrinkage occurs is recessed to be recesses.

Note that depending on exposure conditions, it is considered that not all of the T unit structures are converted into silica (SiO₂) that is the Q unit structure, and there is a component remaining as the T unit structure. Accordingly, the protrusions of the irregularities are composed of the Q unit structures, and the recesses of the irregularities contain the Q unit structure and the T unit structure.

On the other hand, in the Q unit structure (colloidal silica), chemical change does not occur by exposure, and volume shrinkage does not occur either. As a result, in a layer of the resin composition for irregularity formation, recesses are formed only in a portion containing a large amount of T unit structures, and a portion containing a large amount of Q unit structures becomes protrusions. In this manner, the irregularity forming layer 120 having irregularities is formed.

The silanol group remains on the surface of the irregularity forming layer 120 formed in this manner. In particular, the silanol group decomposed from the T unit structure remains in the recesses without being partially condensed. In addition, a part of the Si-alkyl group derived from the T unit structure remains in the recesses. As a result, carbon atoms contained in the recesses have a higher composition ratio than that of carbon atoms contained in the protrusions. As described above, as a result of a large amount of carbon atoms and silanol groups remaining in the recesses, it is possible to more firmly bond with the antifouling layer 130 containing the perfluoropolyether-containing silane compound or the like, and to enhance durability of the antifouling layer 130. Note that a molar concentration of carbon atoms can be measured by an X-ray photoelectron spectrometer.

As a light source used for exposure, any light source may be used as long as the T unit structure can be converted to silica, and for example, a light source having a wavelength of about 150 to 190 nm may be used. Specifically, exposure may be performed by using an excimer lamp, an excimer laser, an F₂ laser, or the like.

The exposure may be performed such that an integrated illuminance is 300 mJ/cm² or more. When the integrated illuminance is less than 1000 mJ/cm², decomposition condensation of the T unit structure is insufficient and irregularities may not be sufficiently formed.

The exposure may be performed such that the integrated illuminance is 6000 mJ/cm² or less. When the integrated illuminance exceeds 6000 mJ/cm², the silanol group does not sufficiently remain on the surface of the recesses, and adhesiveness with the antifouling layer 130 may be insufficient. However, even when the integrated illuminance exceeds 6000 mJ/cm², the irregularity forming layer 120 itself is formed, which sufficiently contributes to improvement of the durability of the antifouling layer, and thus, the integrated illuminance does not necessarily need to be 6000 mJ/cm² or less.

In the description related to FIG. 4, it has been described that the irregularity forming layer 120 is obtained by exposing the organosiloxane-based hard coat agent to light, but the present invention is not limited to this method. The irregularity forming layer 120 may form irregularities on the order of nanometers by performing nanoimprinting, photolithography, plasma treatment, laser treatment, or the like on a thin film formed from a resin material or the like.

Instead of processing of S110 to S130 of FIG. 4, S100 may be executed by forming irregularities on the base material 110. For example, desired irregularities may be formed by performing nanoimprinting, photolithography, plasma treatment, laser treatment, or the like on the base material 110. In this case, the antifouling member 10 as illustrated in FIG. 2 is formed. Processing of S200 is performed after S100.

In S200, the antifouling layer 130 is formed on the irregularities formed in S100. For example, the antifouling layer 130 may be formed by forming, on the irregularities, a layer of a fluorine-containing silane compound having oil repellency and/or water repellency. The antifouling layer 130 may be formed by applying a composition containing the fluorine-containing silane compound onto the irregularities and drying the composition.

Examples of the fluorine-containing silane compound include a perfluoroalkyl group-containing silane compound (particularly, a perfluoropolyether-containing silane compound), an isocyanuric skeleton-containing silane compound, or the like.

Examples of the perfluoroalkyl group-containing silane compound include a compound represented by following Formula (I).

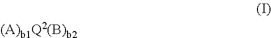

(wherein:
Q² is a linking group having a valence of (b1+b2),
A is a group represented by R^{f3}—O—R^{f2}—,
R^{f2} is a poly(oxyfluoroalkylene) chain,
R^{f3} is a perfluoroalkyl group,
B is a monovalent group having one —R¹²—(SiR²ᵣX²₃₋ᵣ) and containing no fluorine atom,
R¹² is a hydrocarbon group having 2 to 10 carbon atoms, which may have an etheric oxygen atom between carbon atoms or at a terminal opposite to a terminal to which Si is bonded, or may have an —NH— between carbon atoms,
R² is independently a monovalent hydrocarbon group having 1 to 6 carbon atoms, which may have a hydrogen atom or a substituent,
X² is independently a hydroxyl group or a hydrolyzable group, r is an integer of 0 to 2,
Q² and B do not include a cyclic siloxane structure,
b1 is an integer of 1 to 3,
b2 is an integer of 2 to 9, and
here, when b1 is 2 or more, b1 units of A may be identical or different, and b2 units of B may be identical or different)

In Formula (I), A is a group represented by R^{f3}—O—R^{f2}—.

R^{f3} is a perfluoroalkyl group, and a number of at least one carbon atom is preferably 1 to 20, and more preferably 1 to 6. R^{f3} may be linear or branched. Among them, in terms of availability, a linear group: CF₃(CF₂)ₘ₃₋₁ (here, m3 is 1 to 20, preferably 1 to 6) is preferable, CF₃— or CF₃(CF₂)₂— is more preferable, and CF₃(CF₂)₂— is particularly preferable.

R^{f2} is a poly(oxyfluoroalkylene) chain. R^{f2} is, for example, —(CₓF₂ₓO)_{y}— (x is an integer of 1 to 6, y is an integer of 2 or more, and each —CₓF₂ₓO— unit may be identical or different). The —CₓF₂ₓO— unit may be linear or branched, and examples thereof include —CF₂CF₂CF₂CF₂CF₂CF₂O—, —CF₂CF₂CF₂CF₂CF₂O—, —CF₂CF₂CF₂CF₂O—, —CF₂CF₂CF₂O—, —CF(CF₃)CF₂O—, —CF₂CF₂O—, and —CF₂O—. y can be appropriately adjusted according to a desired number-average molecular weight. A preferable upper limit value of y is 200.

R^{f2} may be a combination of a plurality of units, and in this case, each unit may be present in any of a block, alternating, or random sequence. For example, it is preferable to include —CF₂CF₂CF₂CF₂CF₂CF₂O—, —CF₂CF₂CF₂CF₂CF₂O—, and —CF₂CF₂CF₂CF₂O— in terms of excellent light resistance, it is preferable that these structures are present in higher proportions, and it is more preferable that the unit is —CF₂CF₂O—CF₂CF₂CF₂CF₂O— which is a combination of —CF₂CF₂CF₂CF₂O— and —CF₂CF₂O— in terms of ease of synthesis.

Specific examples of R^{f2} include —(CF₂CF₂CF₂CF₂CF₂CF₂O)ₙ₃—(CF₂CF₂CF₂CF₂CF₂O)ₙ₄—(CF₂CF₂CF₂CF₂O)ₙ₅—(CF₂CF₂CF₂O)ₙ₆—(CF(CF₃)CF₂O)ₙ—(CF₂CF₂O)ₙ₈—(CF₂O)ₙ₉— (here, n3, n4, n5, n6, n7, n8, and n9 are each independently an integer of 0 or more, but a total of n3, n4, n5, n6, n7, n8, and n9 is 2 or more, and each repeating unit may be present in any of a block, alternating, or random sequence).

As R^{f2}, {(CF₂O)ₙ₁₁(CF₂CF₂O)ₙ₁₂}, (CF₂CF₂O)ₙ₁₃, (CF₂CF₂CF₂O)ₙ₁₄, and (CF₂CF₂O—CF₂CF₂CF₂CF₂O)ₙ₁₅ are preferable, and {(CF₂O)ₙ₁₁(CF₂CF₂O)n}₁₂ and (CF₂CF₂CF₂O)ₙ₁₄ are more preferable. Here, n11 is an integer of 1 or more, n12 is an integer of 1 or more, n11+n12 is an integer of 2 to 200, and a bonding order of n11 units of CF₂O and n12 units of CF₂CF₂O is not limited. n13 and n14 are integers of 2 to 200, and n15 is an integer of 1 to 100.

In Formula (I), a number (b1) of at least one group A represented by R^{f3}—O—R^{f2}— is an integer of 1 to 3. In Formula (I), when there are a plurality of groups A, the groups A may be identical or different. The group A and a perfluoroalkyl group in a fluoroalkylsilane compound are groups contributing to water repellency of a resulting surface treatment layer. When the perfluoroalkyl group-containing silane compound has a plurality of groups A, a density of R^{f3}—O—R^{f2}— groups is increased, which is preferable from a viewpoint of excellent friction resistance of a surface treatment layer.

In Formula (I), a group B has one —R¹²—(SiR²ᵣX²₃₋ᵣ) (hereinafter, also referred to as a “group (B^{a})”) at its terminal position and is a monovalent group containing no cyclic siloxane structure and no fluorine atom.

The group B is specifically a group represented by —Y^{a}—R¹²—(SiR²ᵣX²₃₋ᵣ). The group (B⁸) and Q² are linked by —Y^{a}—. Y^{a} is a single bond or a divalent organic group containing no cyclic siloxane structure and no fluorine atom. For example, Y^{a} is a divalent group which has an alkylene group containing, at its terminal, an arylene group such as a phenylene group having 6 to 8 carbon atoms (for example, an alkylene or arylene group having 8 to 16 carbon atoms or the like), or an alkylene group (for example, having 1 to 20 carbon atoms) bonded with a silalkylene structure (for example, having 1 to 10 carbon atoms and 2 to 10 Si atoms) or a silarylene structure (for example, 1 to 10 carbon atoms and 2 to 10 Si atoms), and the terminal on the group (B^{a}) side is other than an alkylene group. An atom of Q² to which Y^{a} bonds is an atom constituting a main chain, and specific examples thereof include Si, C, and N. Y^{a} is preferably a single bond.

R¹² is a hydrocarbon group having 2 to 10 carbon atoms which may have an etheric oxygen atom between carbon atoms or at a terminal opposite to a terminal which is bonded to Si, or may have an —NH— between carbon atoms. Specifically, a group selected from a group consisting of —CH₂CH₂—, —CH₂CH₂CH₂—, —CH₂OCH₂CH₂CH₂—, and —OCH₂CH₂CH₂— (where a right side is bonded to Si) is preferable, and in terms of excellent light resistance of the water-repellent film, —CH₂CH₂— and —CH₂CH₂CH₂— having no etheric oxygen atom are particularly preferable. R¹² groups of a plurality of groups B present in Formula (I) may be all identical, or may not be all identical.

X² is a hydroxyl group or a hydrolyzable group, and as for the hydrolyzable group, examples and preferred aspects of the hydrolyzable group for X¹ are applied. r is an integer of 0 to 2, and is preferably 0 or 1, more preferably 0, in terms of excellent adhesion and durability. When a plurality of X² groups are present, the X² groups may be identical or different, but are preferably identical in terms of availability.

R² is a hydrogen atom or a monovalent hydrocarbon group having 1 to 6 carbon atoms, and the hydrocarbon group may contain a substituent. Examples of the hydrocarbon group include a linear or branched alkyl group. Among them, in terms of availability, a linear or branched alkyl group having 1 to 4 carbon atoms is preferable, and a methyl group or an ethyl group is more preferable. Examples of the substituent include halogen atoms (for example, chlorine atoms). r, which is a number of at least one R² group bonded to Si, is an integer of 0 to 2. When a plurality of R² groups are present, the R² groups may be identical or different, but are preferably identical in terms of availability.

In Formula (I), a number of groups B represented by b2 is an integer of 2 to 9. Thus, a number of groups (B^{a}) in the perfluoroalkyl group-containing silane compound is 2 to 9. The group (B^{a}) is a group that contributes to light resistance and abrasion resistance of a resulting water-repellent film. The number of groups B in the perfluoroalkyl group-containing silane compound, that is, the number of groups (B^{a}) is preferably 2 to 4 in terms of excellent light resistance and abrasion resistance of the resulting water-repellent film.

Note that a plurality of groups B of the perfluoroalkyl group-containing silane compound may be identical or different. The groups (B^{a}) may be identical or different.

In Formula (I), Q² is a (b1+b2) valent linking group. Q² is, for example, a hydrocarbon group, and may have an ester bond, an ether bond, an amide bond, a urethane bond, a phenylene group, —S—, a divalent amino group, a silalkylene structure, a silarylene structure, or a siloxane structure (not containing a cyclic siloxane structure) at its terminal or between carbon atoms, and a hydrogen atom of the hydrocarbon group may be substituted with a fluorine atom. The hydrogen atom of the hydrocarbon group may be substituted with a hydroxyl group, but a number of at least one hydroxyl group to be substituted is preferably 1 to 5. The hydrocarbon group may be linear or branched. A number of at least one carbon atom in Q² is preferably 1 to 20, and more preferably 1 to 10.

Note that in Q², the group A and the group B may be bonded to a same atom, but are preferably bonded to different atoms, and bonded atoms are more preferably separated as much as possible in a molecule.

In addition, Q² may have —SiR⁰ᵣ₁X⁴₃₋ᵣ₁ (R⁰, X⁴, and r1 are the same as R², X², and r of the group (B^{a}), respectively) directly bonded to an atom other than a terminal of a molecular chain, but preferably has no hydrolyzable silyl group other than the group (B^{a}) as the perfluoroalkyl group-containing silane compound. Note that when the perfluoroalkyl group-containing silane compound has —SiR⁰ᵣ₁X⁴₃₋ᵣ₁ directly bonded to an atom other than the terminal of the molecular chain, the —SiR⁰ᵣ₁X⁴₃₋ᵣ₁ is not included in SiR²ᵣX²₃₋ᵣ when calculating a molar ratio between SiR¹ₚX¹₃₋ₚ of the compound (1) and SiR²ᵣX²₃₋ᵣ of the perfluoroalkyl group-containing silane compound.

In one aspect, the perfluoroalkyl group-containing silane compound may be a compound represented by any one of following Formula (A1), (A2), (B1), (B2), (C1) or (C2):

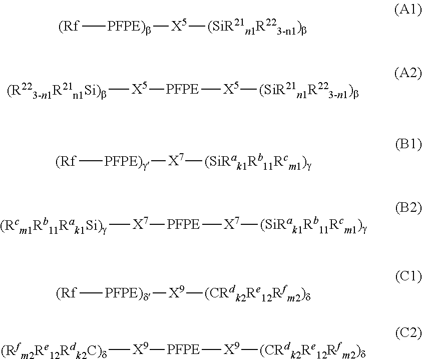

(wherein:
PFPE may be, in each occurrence, independently a group represented by a formula:

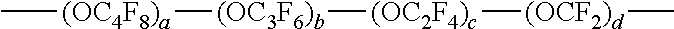

(wherein a, b, c, and d are each independently an integer of 0 to 200, a sum of a, b, c, and d is at least 1, and a sequence of each repeating unit parenthesized with a subscript a, b, c, or d is arbitrary in the formula);
Rf, in each occurrence, independently represents an alkyl group having 1 to 16 carbon atoms which may be substituted with one or more fluorine atoms;
R²¹, in each occurrence, independently represents a hydroxyl group or a hydrolyzable group;
R²², in each occurrence, independently represents a hydrogen atom or an alkyl group having 1 to 22 carbon atoms;
n1 is, independently for each (—SiR²¹ₙ₁R²²₃ₙ₋₁) unit, an integer of 0 to 3;
provided that, in Formulas (A1) and (A2), at least one n1 is an integer of 1 to 3;
X⁵ independently represents a single bond or a 2 to 10 valent organic group;
β is independently an integer of 1 to 9;
β′ is independently an integer of 1 to 9;
X⁷ independently represents a single bond or a 2 to 10 valent organic group;
γ′ is independently an integer of 1 to 9;
γ′ is independently an integer of 1 to 9;
R^{a}, in each occurrence, independently represents —Z¹—SiR⁷¹ₚ₁R⁷²_{q1}R⁷³ᵣ₁;
Z¹, in each occurrence, independently represents an oxygen atom or a divalent organic group;
R⁷¹, in each occurrence, independently represents Ra;
R^{a′} has a same meaning as Ra;
in R^{a}, a number of at least one Si atom linearly linked via a Z¹ group is at most 5;
R⁷², in each occurrence, independently represents a hydroxyl group or a hydrolyzable group;
R⁷³, in each occurrence, independently represents a hydrogen atom or a lower alkyl group;
p1 is, in each occurrence, independently an integer of 0 to 3;
q1 is, in each occurrence, independently an integer of 0 to 3;
r1 is, in each occurrence, independently an integer of 0 to 3;
provided that, in Formulas (B1) and (B2), at least one q1 is an integer of 1 to 3;
R^{b}, in each occurrence, independently represents a hydroxyl group or a hydrolyzable group;
R^{c}, in each occurrence, independently represents a hydrogen atom or a lower alkyl group;
k1 is, in each occurrence, independently an integer of 1 to 3;
l1 is, in each occurrence, independently an integer of 0 to 2;
m1 is, in each occurrence, independently an integer of 0 to 2;
provided that, in a unit parenthesized with γ, a sum of k1, l1 and m1 is 3;
X⁹ independently represents a single bond or a 2 to 10 valent organic group;
δ is independently an integer of 1 to 9;
δ′ is independently an integer of 1 to 9;
R^{d}, in each occurrence, independently represents —Z²—CR⁸¹ₚ₂R⁸²_{q2}R⁸³ᵣ₂;
Z², in each occurrence, independently represents an oxygen atom or a divalent organic group;
R⁸¹, in each occurrence, independently represents R^{d′};
R^{d′} has a same meaning as R^{d};
in R^{d}, a number of at least one C atom linearly linked via a Z² group is at most 5;
R⁸², in each occurrence, independently represents —Y—SiR⁸⁵ₙ₂R⁸⁶₃₋ₙ₂;
Y, in each occurrence, independently represents a divalent organic group;
R⁸⁵, in each occurrence, independently represents a hydroxyl group or a hydrolyzable group;
R⁸⁶, in each occurrence, independently represents a hydrogen atom or a lower alkyl group;
n2 represents, independently for each (—Y—SiR⁸⁵ₙ₂R⁸⁶₃₋ₙ₂) unit, an integer of 0 to 3;
provided that, in Formulas (C1) and (C2), at least one n2 is an integer of 1 to 3;
R⁸³, in each occurrence, independently represents a hydrogen atom, a hydroxyl group or a lower alkyl group;
p2 is, in each occurrence, independently an integer of 0 to 3;
q2 is, in each occurrence, independently an integer of 0 to 3;
r2 is, in each occurrence, independently an integer of 0 to 3;
R^{e}, in each occurrence, independently represents —Y—SiR⁸⁵ₙ₂R⁸⁶₃₋ₙ₂;
R^{f}, in each occurrence, independently represents a hydrogen atom, a hydroxyl group or a lower alkyl group;
k2 is, in each occurrence, independently an integer of 0 to 3;
l2 is, in each occurrence, independently an integer of 0 to 3;
m2 is, in each occurrence, independently an integer of 0 to 3; and provided that, in Formulas (C1) and (C2), at least one q2 is 2 or 3, or at least one 12 is 2 or 3)

### Formulas (A1) and (A2):

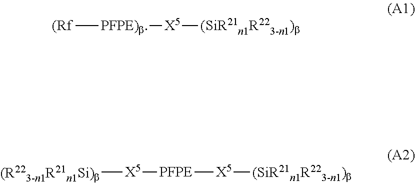

In above Formulas (A1) and (A2), PFPE is, in each occurrence, independently a group represented by

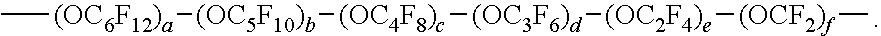

In the formula, a, b, c, d, e, and f are each independently an integer of 0 to 200, and a sum of a, b, c, d, e, and f is at least 1. Preferably, the sum of a, b, c, d, e, and f is 5 or more, and more preferably 10 or more. Preferably, the sum of a, b, c, d, e, and f is 200 or less, more preferably 200 or less, for example, 10 or more and 200 or less, and more specifically 10 or more and 100 or less. In addition, a sequence of each repeating unit parenthesized with a, b, c, d, e, or f is arbitrary in the formula.

The above a and b are each independently preferably 0 or more and 30 or less, and may be 0.

In one aspect, a, b, c, and d are each independently preferably an integer of 0 or more and 30 or less, more preferably an integer of 20 or less, particularly preferably an integer of 10 or less, still more preferably an integer of 5 or less, and may be 0.

In one aspect, a sum of a, b, c, and d is preferably 30 or less, more preferably 20 or less, still more preferably 10 or less, and particularly preferably 5 or less.

In one aspect, a sum of e and f is preferably 30 or more, more preferably 40 or more, and still more preferably 50 or more.

These repeating units may be linear or branched, but are preferably linear. For example, —(OC₆F₁₂)— may be —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, —(OCF₂CF₂CF₂CF₂CF(CF₃))—, or the like, and is preferably —(OCF₂CF₂CF₂CF₂CF₂CF₂)—. —(OC₅F₁₀)— may be —(OCF₂CF₂CF₂CF₂CF₂)—, —(OCF(CF₃)CF₂CF₂CF₂)—, —(OCF₂CF(CF₃)CF₂CF₂)—, —(OCF₂CF₂CF(CF₃)CF₂)—, —(OCF₂CF₂CF₂CF(CF₃))—, or the like, but is preferably —(OCF₂CF₂CF₂CF₂CF₂)—. —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, or —(OCF₂CF(C₂F₅))—, and is preferably —(OCF₂CF₂CF₂CF₂)—. —(OC₃F₆)— may be any of —(OCF₂CF₂CF₂)—, —(OCF(CF₃)CF₂)—, or —(OCF₂CF(CF₃))—, and is preferably —(OCF₂CF₂CF₂)—. In addition, —(OC₂F₄)— may be any of —(OCF₂CF₂)— or —(OCF(CF₃))—, but is preferably —(OCF₂CF₂)—.

In one aspect, the PFPE is —(OC₃F₆)_{d}— (wherein d is an integer of 1 or more and 200 or less, preferably 5 or more and 200 or less, and more preferably 10 or more and 200 or less). Preferably, the PFPE is —(OCF₂CF₂CF₂)_{d}— (wherein d is an integer of 1 or more and 200 or less, preferably 5 or more and 200 or less, and more preferably 10 or more and 200 or less) or —(OCF(CF₃)CF₂)_{d}— (wherein d is an integer of 1 or more and 200 or less, preferably 5 or more and 200 or less, and more preferably 10 or more and 200 or less). More preferably, the PFPE is —(OCF₂CF₂CF₂)_{d}— (wherein d is an integer of 1 or more and 200 or less, preferably 5 or more and 200 or less, and more preferably 10 or more and 200 or less).

In another aspect, the PFPE is —(OC₄F₈)_{c}—(OC₃F₆)_{d}—(OC₂F₄)ₑ—(OCF₂)_{f}— (wherein c and d are each independently an integer of 0 or more and 30 or less, e and f are each independently an integer of 1 or more and 200 or less, preferably 5 or more and 200 or less, and more preferably 10 or more and 200 or less, a sum of c, d, e, and f is at least 5 or more, preferably 10 or more, and a sequence of each repeating unit parenthesized with a subscript c, d, e, or f is arbitrary in the formula). Preferably, the PFPE is —(OCF₂CF₂CF₂CF₂)_{c}—(OCF₂CF₂CF₂)_{d}—(OCF₂CF₂)ₑ—(OCF₂)_{f}—.

In one aspect, the PFPE may be —(OC₂F₄)ₑ—(OCF₂)_{f}— (wherein e and fare each independently an integer of 1 or more and 200 or less, preferably 5 or more and 200 or less, and more preferably 10 or more and 200 or less, and a sequence of each repeating unit parenthesized with a subscript e or f is arbitrary in the formula).

In still another aspect, the PFPE is a group represented by —(R⁶—R⁷)ⱼ—. In the formula, R⁶ is, in each occurrence, independently OCF₂ or OC₂F₄, preferably OC₂F₄. In the formula, R⁷ is, in each occurrence, independently a group selected from OC₂F₄, OC₃F₆, OC₄F₈, OC₅F₁₀ and OC₆F₁₂, or a combination of 2 or 3 groups independently selected from these groups. Preferably, R⁷ is a group selected from OC₂F₄, OC₃F₆ and OC₄F₈ or a group selected from OC₃F₆, OC₄F₈, OC₅F₁₀, and OC₆F₁₂, or a combination of two or three groups independently selected from these groups. The combination of two or three groups independently selected from OC₂F₄, OC₃F₆, and OC₄F₈ is not particularly limited, and examples thereof include —OC₂F₄OC₃F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, —OC₄F₈OC₂F₄OC₂F₄, or the like. The j is an integer of 2 or more, preferably 3 or more, more preferably 5 or more and 100 or less, preferably 50 or less. In the above formula, OC₂F₄, OC₃F₆, OC₄F₈, OC₅F₁₀ and OC₆F₁₂ may be linear or branched, preferably linear. In this aspect, the PFPE is preferably —(OC₂F₄—OC₃F₆) j- or —(OC₂F₄—OC₄F₈)ⱼ—.

In PFPE, the ratio of e to f (hereinafter, referred to as “e/f ratio”) is 0.1 or more and 10 or less, preferably 0.2 or more and 5 or less, more preferably 0.2 or more and 2 or less, and still more preferably 0.2 or more and 1.5 or less. By setting the e/f ratio within the above range, water repellency, oil repellency, and chemical resistance (for example, durability against brine, acid or basic aqueous solutions, acetone, oleic acid or hexane) of a surface treatment layer obtained from a surface treatment agent of the present disclosure can be further improved. The smaller the e/f ratio, the better the water repellency, oil repellency, and chemical resistance of the surface treatment layer. On the other hand, by setting the e/f ratio to 0.1 or more, stability of the compound can be further enhanced. The greater the e/f ratio, the better the stability of the compound.

In the above formula, Rf represents an alkyl group having 1 to 16 carbon atoms which may be substituted with one or more fluorine atoms.

The “alkyl group having 1 to 16 carbon atoms” in the alkyl group having 1 to 16 carbon atoms which may be substituted with one or more fluorine atoms may be a linear or branched alkyl group, preferably a linear or branched alkyl group having 1 to 6 carbon atoms, particularly 1 to 3 carbon atoms, and more preferably a linear alkyl group having 1 to 3 carbon atoms.

The Rf is preferably an alkyl group having 1 to 16 carbon atoms substituted with one or more fluorine atoms, more preferably a CF₂H—C₁₋₁₅ fluoroalkylene group, and still more preferably a perfluoroalkyl group having 1 to 16 carbon atoms.

The perfluoroalkyl group having 1 to 16 carbon atoms may be linear or branched, and is preferably a linear or branched perfluoroalkyl group having 1 to 6 carbon atoms, particularly 1 to 3 carbon atoms, and more preferably a linear perfluoroalkyl group having 1 to 3 carbon atoms, specifically —CF₃, —CF₂CF₃, or —CF₂CF₂CF₃.

In the above formula, R²¹, in each occurrence, independently represents a hydroxyl group or a hydrolyzable group.

In the above formula, R²², in each occurrence, independently represents a hydrogen atom or an alkyl group having 1 to 22 carbon atoms, preferably an alkyl group having 1 to 4 carbon atoms.

In the above formula, n1 is, independently for each (—SiR²¹ₙ₁R²²₃₋ₙ₁) unit, an integer of 0 to 3, preferably 1 to 3, and more preferably 3. However, in the formula, not all n1 are simultaneously 0. In other words, at least one R²¹ is present in the formula.

In the above formula, X⁵ independently represents a single bond or a 2 to 10 valent organic group. In the compounds represented by Formulas (A1) and (A2), the X⁵ is understood to be a linker which links a perfluoropolyether moiety which mainly provides water repellency, surface slidability, or the like (Rf-PFPE moiety or -PFPE-moiety) and a silane moiety which provides a bonding ability to a base material (specifically, —SiR²¹ₙ₁R²²₃₋ₙ₁). Therefore, the X⁵ may be any organic group as long as the compounds represented by Formulas (A1) and (A2) can be stably present.

In the above formula, β is an integer of 1 to 9, and β′ is an integer of 1 to 9. These 3 and 3′ are determined according to a valence of X³, and in Formula (A1), a sum of β and β′ is the same as a valence of X⁵. For example, when X⁵ is a 10 valent organic group, the sum of β and β′ is 10, for example, β may be 9 and β′ may be 1, β may be 5 and β′ may be 5, or β may be 1 and β′ may be 9. In addition, when X⁵ is a divalent organic group, β and β′ are 1. In Formula (A2), β is a value obtained by subtracting 1 from the valence value of X⁵.

The X⁵ is preferably an organic group having a valency of 2 to 7, more preferably 2 to 4, and still more preferably 2.

In one aspect, X⁵ is a 2 to 4 valent organic group, β is 1 to 3, and β′ is 1.

In another aspect, X⁵ is a divalent organic group, β is 1, and β′ is 1. In this case, Formulas (A1) and (A2) are represented by following Formulas (A1′) and (A2′).

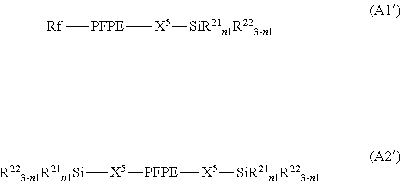

Examples of the X⁵ include, but are not particularly limited to, a single bond or a divalent group represented by a following formula:

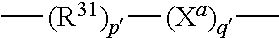

(wherein,
R³¹, in each occurrence, independently represents a single bond, —(CH₂)_{s′}—, or an o-, m- or p-phenylene group, preferably —(CH₂)_{s′}—,
s′ is an integer of 1 to 20, preferably an integer of 1 to 6, more preferably an integer of 1 to 3, still more preferably 1 or 2,
X^{a}, in each occurrence, independently represents —(X^{b})_{l′}—,
X^{b}, in each occurrence, independently represents a group selected from a group consisting of —O—, —S—, an o-, m- or p-phenylene group, —C(O)O—, —Si(R³³)₂—, —(Si(R³³)₂O)_{m′}—Si(R³³)₂—, —CONR³⁴—, —O—CONR³⁴—, —NR³⁴—, and —(CH₂)_{n′}—,
R³³, in each occurrence, independently represents a phenyl group, a C₁₋₆ alkyl group or a C₁₋₆ alkoxy group, preferably a phenyl group or a C₁₋₆ alkyl group, more preferably a methyl group,
R³⁴, in each occurrence, independently represents a hydrogen atom, a phenyl group or a C₁₋₆ alkyl group (preferably a methyl group),
m′ is, in each occurrence, independently an integer of 1 to 100, preferably an integer of 1 to 20,
n′ is, in each occurrence, independently an integer of 1 to 20, preferably an integer of 1 to 6, more preferably an integer of 1 to 3,
l′ is an integer of 1 to 10, preferably an integer of 1 to 5, more preferably an integer of 1 to 3,
p′ is 0, 1 or 2, and
q′ is 0 or 1,
wherein at least one of p′ or q′ is 1, and a sequence of each repeating unit parenthesized with p′ or q′ is arbitrary)

Herein, R³¹ and X^{a} (typically hydrogen atoms of R³¹ and X^{a}) may be substituted with one or more substituents selected from a fluorine atom, a C₁₋₃ alkyl group, and a C₁₋₃ fluoroalkyl group.

In one aspect, l′ is 1.

Preferably, the X⁵ is —(R³¹)_{p′}—(X^{a})_{q′}—R³²—. R³² represents a single bond, —(CH₂)_{t′}—, or an o-, m- or p-phenylene group, preferably —(CH₂)_{t′}—. t′ is an integer of 1 to 20, preferably an integer of 2 to 6, more preferably an integer of 2 to 3. Herein, R³² (typically hydrogen atoms of R³²) may be substituted with one or more substituents selected from a fluorine atom, a C₁₋₃ alkyl group and a C₁₋₃ fluoroalkyl group.

Preferably, the X⁵ may be a single bond or a group represented by —R^{f′}—X¹²— (wherein, X¹² is a C₁₋₂₀ alkylene group, —R³¹—X^{c}—R³²—, or —X^{d}—R³²— (wherein, R³¹ and R³² have same meanings as described above), R^{f′} is a single bond or —(C_{l′}F_{2l′})—, and l′ is an integer of 1 to 4).

Note that the alkylene group is a group having a —(CₙH₂ₙ)— structure, and may be substituted or unsubstituted, and may be linear or branched.

Still more preferably, the X⁵ is
—X^{f}—,
a —X^{f}—C₁₋₂₀ alkylene group,
—X^{f}—(CH₂)_{s′}—X—,
—X^{f}—(CH₂)_{s′}—X^{c}—(CH₂)_{t′}—
—X^{f}—X^{d}—, or
—X^{f}—X^{d}—(CH₂)_{t′}—.

In the formula, s′ and t′ have same meanings as described above.

In the above formula, X^{f} is an alkylene group having 1 to 6 carbon atoms, preferably 1 to 4 carbon atoms, more preferably 1 to 2 carbon atoms, for example, a methylene group. The hydrogen atom in X^{f} may be substituted, preferably substituted, with one or more substituents selected from a fluorine atom, a C₁₋₃ alkyl group, and a C₁₋₃ fluoroalkyl group. X^{f} may be linear or branched, and is preferably linear.

More preferably, the X⁵ may be
a single bond or a group represented by —Rf′—X¹³—
(wherein X¹³ is
a C₁₋₂₀ alkylene group,
—(CH₂)_{s′}—X′—,
—(CH₂)_{s′}—X^{c}—(CH₂)_{t′}—,
—X^{d}—, or
—X^{d}—(CH₂)_{t′}—
(wherein, s′ and t′ have the same meanings as described above),
Rf′ is a single bond or —(C_{l′}F_{2l′})—, and
l′ is an integer of 1 to 4).

In the above formula, X represents
—O—,
—S—,
—C(O)O—,
—CONR³⁴—,
—O—CONR³⁴—,
—Si(R³³)₂—,
—(Si(R³³)₂O)_{m′}—Si(R³³)₂—,
—O—(CH₂)_{u′}—(Si(R³³)₂O)_{m′}—Si(R³³)₂—,
—O—(CH₂)_{u′}—Si(R³³)₂—O—Si(R³³)₂—CH₂CH₂—Si(R³³)₂—O—Si(R³³)₂—,
—O—(CH₂)_{u′}—Si(OCH₃)₂OSi(OCH₃)₂—,
—CONR³⁴—(CH₂)_{u′}—(Si(R³³)₂O)_{m′}—Si(R³³)₂—,
—CONR³⁴—(CH₂)_{u′}—N(R³⁴)—, or
—CONR³⁴-(o-, m- or p-phenylene)-Si(R³³)₂—
(wherein R³³, R³⁴, and m′ have same meanings as described above, and
u′ is an integer of 1 to 20, preferably an integer of 2 to 6, more preferably an integer of 2 to 3).

X^{c} is preferably —O—.

In the above formula, X^{d} represents
—S—,
—C(O)O—,
—CONR³⁴—,
—CONR³⁴—(CH₂)_{u′}—(Si(R³³)₂O)_{m′}—Si(R³³)₂—,
—CONR³⁴—(CH₂)_{u′}—N(R³⁴)—, or
—CONR³⁴-(o-, m- or p-phenylene)-Si(R³³)₂—
(wherein, each symbol has a same meaning as described above).

Particularly preferably, the X⁵ is a group represented by
—X^{f}—,
a —X^{f}—C₁₋₂₀ alkylene group,
—X^{f}—(CH₂)_{s′}—X^{c}—,
—X^{f}—(CH₂)_{s′}—X^{c}—(CH₂)_{t′}—,
—X^{f}—X^{d}—, or
—X^{f}—X^{d}—(CH₂)_{t′}—
(wherein, X^{f}, s′ and t′ have the same meanings as described above),
X is —O— or —CONR³⁴—,
X^{d} is —CONR³⁴—, and
R³⁴, in each occurrence, independently represents a hydrogen atom, a phenyl group or a C₁₋₆ alkyl group (preferably a methyl group)).

In one aspect, the X⁵ is a group represented by
—X^{f}—(CH₂)_{s′}—X^{c}—,
—X^{f}—(CH₂)_{s′}—X^{c}—(CH₂)_{t′}—,
—X^{f}—X^{d}—, or
—X^{f}—X^{d}—(CH₂)_{t′}—
(wherein, X^{f}, s′ and t′ have the same meanings as described above),
X^{c} is —CONR³⁴—
X^{d} is —CONR³⁴—, and
R³⁴, in each occurrence, independently represents a hydrogen atom, a phenyl group or a C₁₋₆ alkyl group (preferably a methyl group)).

In one aspect, the X⁵ may be
a single bond,
a C₁₋₂₀ alkylene group,
—(CH₂)_{s′}—X^{c}—(CH₂)_{t′}—, or
—X^{d}—(CH₂)_{t′}—
(wherein, each symbol has a same meaning as described above).

Preferably, the X⁵ is a group represented by
a single bond or —R^{f′}—X¹⁴—
(wherein, X¹⁴ is
a C₁₋₂₀ alkylene group,
(CH₂)_{s′}—O—(CH₂)_{t′}—,
—(CH₂)_{s′}—(Si(R³³)₂O)_{m′}—Si(R³³)₂—(CH₂)_{t′}—,
—(CH₂)_{s′}—O—(CH₂)_{u′}—(Si(R³³)₂O)_{m′}—Si(R³³)₂—(CH₂)_{t′}—, or
—(CH₂)_{s′}—O—(CH₂)_{t′}—Si(R³³)₂—(CH₂)_{u′}—Si(R³³)₂—(CᵥH₂ᵥ)—
(wherein, R³³, m′, s′, t′ and u′ have same meanings as above, and v is an integer of 1 to 20, preferably an integer of 2 to 6, more preferably an integer of 2 to 3),
Rf′ is a single bond or —(C_{l′}F_{2l′})—, and
l′ is an integer of 1 to 4).

In the above formula, —(CᵥH₂ᵥ)— may be linear or branched, and may be, for example, —CH₂CH₂—, —CH₂CH₂CH₂—, —CH(CH₃)—, or —CH(CH₃)CH₂—.

The X⁵ group may be substituted with one or more substituents selected from a fluorine atom, a C₁₋₃ alkyl group, and a C₁₋₃ fluoroalkyl group (preferably a C₁₋₃ perfluoroalkyl group).

In another aspect, examples of the X⁵ group include following groups:

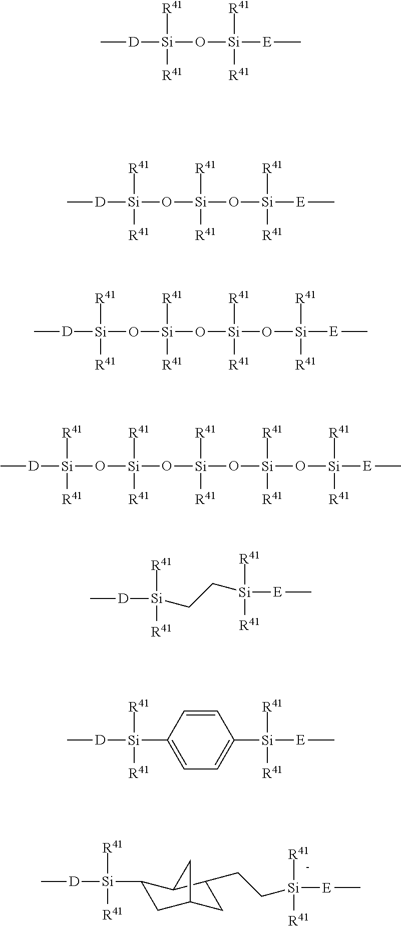

(wherein, R⁴¹ independently represents a hydrogen atom, a phenyl group, an alkyl group having 1 to 6 carbon atoms, or a C₁₋₆ alkoxy group, preferably a methyl group;
D is a group represented by —Rf′—X¹⁵—
(wherein, X¹⁵ is a group selected from
—CH₂O(CH₂)₂—,
—CH₂O(CH₂)₃—,
—CF₂O(CH₂)₃—,
—(CH₂)₂—,
—(CH₂)₃—,
—(CH₂)₄—,
—CONH—(CH₂)—,
—CONH—(CH₂)₂—,
—CONH—(CH₂)₃—,
—CON(CH₃)—(CH₂)₃—, —CON(Ph)-(CH₂)₃— (wherein Ph means phenyl), and

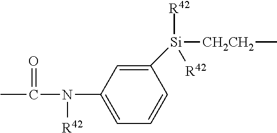

(wherein R⁴² independently represents a hydrogen atom, a C₁₋₆ alkyl group, or a C₁₋₆ alkoxy group, preferably a methyl group or a methoxy group, more preferably a methyl group),
Rf′ is a single bond or —(C_{l′}F_{2l′})—, and
l′ is an integer of 1 to 4),
E is —(CH₂)ₙ— (n is an integer of 2 to 6),
D is bonded to PFPE of a molecular main chain, and E is bonded to an opposite group of the PFPE)

For example, specific examples of the X⁵ include:
a single bond or a group represented by —Rf′—X¹⁰—
(wherein, X¹⁰ is a group selected from a group consisting of
—CH₂OCH₂—,
—CH₂O(CH₂)₂—,
—CH₂O(CH₂)₃—,
—CH₂O(CH₂)₆—,
—CF₂—CH₂—O—CH₂—,
—CF₂—CH₂—O—(CH₂)₂—,
—CF₂—CH₂—O—(CH₂)₃—,
—CF₂—CH₂—O—(CH₂)₆—,
—CH₂O(CH₂)₃Si(CH₃)₂OSi(CH₃)₂(CH₂)₂—,
—CH₂O(CH₂)₃Si(CH₃)₂OSi(CH₃)₂OSi(CH₃)₂(CH₂)₂—,
—CH₂O(CH₂)₃Si(CH₃)₂O(Si(CH₃)₂O)₂Si(CH₃)₂(CH₂)₂—,
—CH₂O(CH₂)₃Si(CH₃)₂O(Si(CH₃)₂O)₃Si(CH₃)₂(CH₂)₂—,
—CH₂O(CH₂)₃Si(CH₃)₂O(Si(CH₃)₂O)₁₀Si(CH₃)₂(CH₂)₂—,
—CH₂O(CH₂)₃Si(CH₃)₂O(Si(CH₃)₂O)₂₀Si(CH₃)₂(CH₂)₂—,
—CH₂OCF₂CHFOCF₂—,
—CH₂OCF₂CHFOCF₂CF₂—,
—CH₂OCF₂CHFOCF₂CF₂CF₂—,
—CH₂OCH₂CF₂CF₂OCF₂—,
—CH₂OCH₂CF₂CF₂OCF₂CF₂—,
—CH₂OCH₂CF₂CF₂OCF₂CF₂CF₂—,
—CH₂OCH₂CF₂CF₂OCF(CF₃)CF₂OCF₂—,
—CH₂OCH₂CF₂CF₂OCF(CF₃)CF₂OCF₂CF₂—,
—CH₂OCH₂CF₂CF₂OCF(CF₃)CF₂OCF₂CF₂CF₂—,
—CH₂OCH₂CHFCF₂OCF₂—,
—CH₂OCH₂CHFCF₂OCF₂CF₂—,
—CH₂OCH₂CHFCF₂OCF₂CF₂CF₂—,
—CH₂OCH₂CHFCF₂OCF(CF₃)CF₂OCF₂—,
—CH₂OCH₂CHFCF₂OCF(CF₃)CF₂OCF₂CF₂—,
—CH₂OCH₂CHFCF₂OCF(CF₃)CF₂OCF₂CF₂CF₂—,
—CH₂OCF₂CHFOCF₂CF₂CF₂—C(O)NH—CH₂—,
—CH₂OCH₂(CH₂)₇CH₂Si(OCH₃)₂OSi(OCH₃)₂(CH₂)₂Si(OCH₃)₂OSi(OCH₃)₂(CH₂)₂—,
—CH₂OCH₂CH₂CH₂Si(OCH₃)₂OSi(OCH₃)₂(CH₂)₃—,
—CH₂OCH₂CH₂CH₂Si(OCH₂CH₃)₂OSi(OCH₂CH₃)₂(CH₂)₃—,
—CH₂OCH₂CH₂CH₂Si(OCH₃)₂OSi(OCH₃)₂(CH₂)₂—,
—CH₂OCH₂CH₂CH₂Si(OCH₂CH₃)₂OSi(OCH₂CH₃)₂(CH₂)₂—,
—(CH₂)₂—Si(CH₃)₂—(CH₂)₂—,
—CH₂—,
—(CH₂)₂—,
—(CH₂)₃—,
—(CH₂)₄—,
—(CH₂)₅—,
—(CH₂)₆—,
—CF₂—,
—(CF₂)₂—,
—CF₂—CH₂—,
—CF₂—(CH₂)₂—,
—CF₂—(CH₂)₃—,
—CF₂—(CH₂)₄—,
—CF₂—(CH₂)₅—,
—CF₂—(CH₂)₆—,
—CO—
—CONH—
—CONH—CH₂—,
—CONH—(CH₂)₂—,
—CONH—(CH₂)₃—,
—CONH—(CH₂)₆—,
—CF₂CONH—,
—CF₂CONHCH₂—,
—CF₂CONH(CH₂)₂—,
—CF₂CONH(CH₂)₃—,
—CF₂CONH(CH₂)₆—,
—CON(CH₃)—(CH₂)₃—,
—CON(Ph)-(CH₂)₃— (wherein Ph means phenyl),
—CON(CH₃)—(CH₂)₆—,
—CON(Ph)-(CH₂)₆— (wherein Ph means phenyl),
—CF₂—CON(CH₃)—(CH₂)₃—,
—CF₂—CON(Ph)-(CH₂)₃— (wherein Ph means phenyl),
—CF₂—CON(CH₃)—(CH₂)₆—,
—CF₂—CON(Ph)-(CH₂)₆— (wherein Ph means phenyl),
—CONH—(CH₂)₂NH(CH₂)₃—,
—CONH—(CH₂)₆NH(CH₂)₃—,
—CH₂O—CONH—(CH₂)₃—,
—CH₂O—CONH—(CH₂)₆—,
—S—(CH₂)₃—,
—(CH₂)₂S(CH₂)₃—,
—CONH—(CH₂)₃Si(CH₃)₂OSi(CH₃)₂(CH₂)₂—,
—CONH—(CH₂)₃Si(CH₃)₂OSi(CH₃)₂OSi(CH₃)₂(CH₂)₂—,
—CONH—(CH₂)₃Si(CH₃)₂O(Si(CH₃)₂O)₂Si(CH₃)₂(CH₂)₂—,
—CONH—(CH₂)₃Si(CH₃)₂O(Si(CH₃)₂O)₃Si(CH₃)₂(CH₂)₂—,
—CONH—(CH₂)₃Si(CH₃)₂O(Si(CH₃)₂O)₁₀Si(CH₃)₂(CH₂)₂—,
—CONH—(CH₂)₃Si(CH₃)₂O(Si(CH₃)₂O)₂₀Si(CH₃)₂(CH₂)₂—,
—C(O)O—(CH₂)₃—,
—C(O)O—(CH₂)₆—,
—CH₂—O—(CH₂)₃—Si(CH₃)₂—(CH₂)₂—Si(CH₃)₂—(CH₂)₂—,
—CH₂—O—(CH₂)₃—Si(CH₃)₂—(CH₂)₂—Si(CH₃)₂—CH(CH₃)—,
—CH₂—O—(CH₂)₃—Si(CH₃)₂—(CH₂)₂—Si(CH₃)₂—(CH₂)₃—,
—CH₂—O—(CH₂)₃—Si(CH₃)₂—(CH₂)₂—Si(CH₃)₂—CH(CH₃)—CH₂—,
—OCH₂—,
—O(CH₂)₃—, and
—OCFHCF₂—,

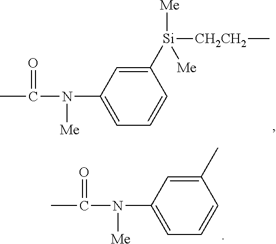

Rf′ is a single bond or —(C_{l′}F_{2l′})—, and
l′ is an integer of 1 to 4), or the like.

In a more preferred aspect, X⁵ represents X^{e′}. X^{e′} is a single bond, an alkylene group having 1 to 6 carbon atoms, —R⁵¹—C₆H₄—R⁵²—, —R⁵¹—CONR⁴—R⁵²—, —R⁵¹—CONR⁴—C₆H₄—R⁵²—, —R⁵¹—CO—R⁵²—, —R⁵¹—CO—C₆H₄—R⁵²—, —R⁵¹—SO₂NR⁴—R⁵²—, —R⁵¹—SO₂NR⁴—C₆H₄—R⁵²—, —R⁵¹—SO₂—R⁵²—, or —R⁵¹—SO₂—C₆H₄—R⁵²—. R⁵¹ and R⁵² each independently represent a single bond or an alkylene group having 1 to 6 carbon atoms, and is preferably a single bond or an alkylene group having 1 to 3 carbon atoms. R⁴ has a same meaning as described above. The alkylene group is substituted or unsubstituted, preferably unsubstituted. Examples of a substituent of the alkylene group can include a halogen atom, preferably a fluorine atom. The alkylene group is linear or branched, and preferably linear.

In a further preferred aspect, X^{e′} may be
a single bond,
—X^{f}—,
an alkylene group having 1 to 6 carbon atoms, preferably 1 to 3 carbon atoms,
a —X^{f}—C₁₋₆ alkylene group, preferably a —X^{f}—C₁₋₃ alkylene group, more preferably
a —X^{f}—C₁₋₂ alkylene group,
—C₆H₄—R⁵²—,
—CONR^{4′}—R⁵²—,
—CONR⁴—C₆H₄—R⁵²—,
—X^{f}—CONR^{4′}—R⁵²—,
—X^{f}—CONR^{4′}—C₆H₄—R⁵²—,
—CO—R⁵²—,
—CO—C₆H₄—R⁵²—,
—SO₂NR^{4′}—R⁵²—,
—SO₂NR^{4′}—C₆H₄—R⁵²—,
—SO₂—R⁵²—,
—SO₂—C₆H₄—R⁵²—,
—R_{51′}—C₆H₄—,
—R^{51′}—CONR^{4′}—,
—R^{51′}—CONR^{4′}—C₆H₄—,
—R^{51′}—CO—,
—R^{51′}—CO—C₆H₄—,
—R^{51′}—SO₂NR^{4′}—,
—R^{51′}—SO₂NR^{4′}—C₆H₄—,
—R^{51′}—SO₂—,
—R^{51′}—SO₂—C₆H₄—,
—C₆H₄—
—CONR^{4′}—,
—CONR^{4′}—C₆H₄—,
—X^{f}—CONR^{4′}—,
—X^{f}—CONR^{4′}—C₆H₄—,
—CO—,
—CO—C₆H₄—,
—SO₂NR^{4′}—,
—SO₂NR^{4′}—C₆H₄—,
—SO₂—, or
—SO₂—C₆H₄—
(wherein R^{51′} and R^{52′} are each independently a linear alkylene group having 1 to 6 carbon atoms, preferably 1 to 3 carbon atoms, and as described above, the alkylene group is substituted or unsubstituted, and examples of a substituent of the alkylene group can include a halogen atom, preferably a fluorine atom.

R^{4′} is a hydrogen atom or a methyl group).

Preferably, among the above, X^{e′} may be
—X^{f}—,
an alkylene group having 1 to 6 carbon atoms, preferably 1 to 3 carbon atoms,
a —X^{f}—C₁₋₆ alkylene group, preferably a —X^{f}—C₁₋₃ alkylene group, more preferably
a —X^{f}—C₁₋₂ alkylene group,
—CONR^{4′}—R^{52′}—,
—CONR^{4′}—C₆H₄—R^{52′}—,
—X^{f}—CONR^{4′}—R^{52′}—,
—X^{f}—CONR^{4′}—C₆H₄—R^{52′}—,
—R^{51′}—CONR^{4′}—,
—R^{51′}—CONR^{4′}—C₆H₄—,
—CONR^{4′}—,
—CONR^{4′}—C₆H₄—,
—X^{f}—CONR^{4′}—,
—X^{f}—CONR^{4′}—C₆H₄—,
—R^{51′}—CONR^{4′}—, or
—R^{51′}—CONR^{4′}—C₆H₄—.

In the formula, X^{f}, R⁴, R⁵¹ and R^{52′} each have a same meaning as described above.

More preferably, among the above, X^{e′} may be
—CONR^{4′}—R^{52′}—,
—CONR^{4′}—C₆H₄—R^{52′}—,
—X^{f}—CONR^{4′}—R^{52′}—,
—X^{f}—CONR^{4′}—C₆H₄—R^{52′}—,
—R^{51′}—CONR^{4′}—,
—R^{51′}—CONR^{4′}—C₆H₄—,
—CONR^{4′}—,
—CONR^{4′}—C₆H₄—,
—X^{f}—CONR^{4′}—, or
—X^{f}—CONR^{4′}—C₆H₄—.

In this aspect, for example, specific examples of X^{e′} include
a single bond,
a perfluoroalkylene group having 1 to 6 carbon atoms (for example, —CF₂—, —(CF₂)₂—, or the like),
an alkylene group having 1 to 6 carbon atoms,
a —CF₂—C₁₋₆ alkylene group,
—CONH—,
—CONH—CH₂—,
—CONH—(CH₂)₂—
—CONH—(CH₂)₃—,
—CF₂—CONH—,
—CF₂CONHCH₂—,
—CF₂CONH(CH₂)₂—,
—CF₂CONH(CH₂)₃—,
—CON(CH₃)—,
—CON(CH₃)—CH₂—,
—CON(CH₃)—(CH₂)₂—,
—CON(CH₃)—(CH₂)₃—,
—CF₂—CON(CH₃)—,
—CF₂—CON(CH₃)CH₂—,
—CF₂—CON(CH₃)—(CH₂)₂—,
—CF₂—CON(CH₃)—(CH₂)₃—,
—CH₂—CONH—,
—CH₂—CONH—CH₂—,
—CH₂—CONH—(CH₂)₂—,
—CH₂—CONH—(CH₂)₃—,
—CF₂—CH₂—CONH—,
—CF₂—CH₂—CONH—CH₂—,
—CF₂—CH₂—CONH—(CH₂)₂—,
—CF₂—CH₂—CONH—(CH₂)₃—,
—CONH—C₆H₄—,
—CON(CH₃)—C₆H₄—,
—CH₂—CON(CH₃)—CH₂—,
—CH₂—CON(CH₃)—(CH₂)₂—,
—CH₂—CON(CH₃)—(CH₂)₃—,
—CON(CH₃)—C₆H₄—,
—CF₂—CONH—C₆H₄—,
—CF₂—CON(CH₃)—C₆H₄—,
—CF₂—CH₂—CON(CH₃)—CH₂—,
—CF₂—CH₂—CON(CH₃)—(CH₂)₂—,
—CF₂—CH₂—CON(CH₃)—(CH₂)₃—,
—CF₂—CON(CH₃)—C₆H₄—,
—CO—,
—CO—C₆H₄—,
—C₆H₄—,
—SO₂NH—,
—SO₂NH—CH₂—,
—SO₂NH—(CH₂)₂—,
—SO₂NH—(CH₂)₃—,
—SO₂NH—C₆H₄—,
—SO₂N(CH₃)—,
—SO₂N(CH₃)—CH₂—,
—SO₂N(CH₃)—(CH₂)₂—,
—SO₂N(CH₃)—(CH₂)₃—,
—SO₂N(CH₃)—C₆H₄—,
—SO₂—,
—SO₂—CH₂—,
—SO₂—(CH₂)₂—,
—SO₂—(CH₂)₃—,
—SO₂—C₆H₄—,
or the like.

Among the above lists, examples of preferable X^{e′} include
an alkylene group having 1 to 6 carbon atoms,
a perfluoroalkylene group having 1 to 6 carbon atoms (for example, —CF₂—, —(CF₂)₂—, or the like),
a —CF₂—C₁₋₆ alkylene group,
—CONH—,
—CONH—CH₂—,
—CONH—(CH₂)₂—,
—CONH—(CH₂)₃—,
—CF₂CONH—,
—CF₂CONHCH₂—,
—CF₂CONH(CH₂)₂—,
—CF₂CONH(CH₂)₃—,
—CON(CH₃)—,
—CON(CH₃)—CH₂—,
—CON(CH₃)—(CH₂)₂—,
—CON(CH₃)—(CH₂)₃—,
—CF₂—CON(CH₃)—,
—CF₂—CON(CH₃)CH₂—,
—CF₂—CON(CH₃)—(CH₂)₂—,
—CF₂—CON(CH₃)—(CH₂)₃—,
—CH₂—CONH—,
—CH₂—CONH—CH₂—,
—CH₂—CONH—(CH₂)₂—,
—CH₂—CONH—(CH₂)₃—,
—CF₂—CH₂—CONH—,
—CF₂—CH₂—CONH—CH₂—,
—CF₂—CH₂—CONH—(CH₂)₂—,
—CF₂—CH₂—CONH—(CH₂)₃—,
—CONH—C₆H₄—,
—CON(CH₃)—C₆H₄—,
—CH₂—CON(CH₃)—CH₂—,
—CH₂—CON(CH₃)—(CH₂)₂—,
—CH₂—CON(CH₃)—(CH₂)₃—,
—CON(CH₃)—C₆H₄—
—CF₂—CONH—C₆H₄—,
—CF₂—CON(CH₃)—C₆H₄—,
—CF₂—CH₂—CON(CH₃)—CH₂—,
—CF₂—CH₂—CON(CH₃)—(CH₂)₂—,
—CF₂—CH₂—CON(CH₃)—(CH₂)₃—,
—CF₂—CON(CH₃)—C₆H₄—,
or the like.

Among the above lists, examples of more preferable X^{e′} include
—CONH—,
—CONH—CH₂—,
—CONH—(CH₂)₂—,
—CONH—(CH₂)₃—,
—CF₂CONH—,
—CF₂CONHCH₂—,
—CF₂CONH(CH₂)₂—,
—CF₂CONH(CH₂)₃—,
—CON(CH₃)—,
—CON(CH₃)—CH₂—,
—CON(CH₃)—(CH₂)₂—,
—CON(CH₃)—(CH₂)₃—,
—CF₂—CON(CH₃)—,
—CF₂—CON(CH₃)CH₂—,
—CF₂—CON(CH₃)—(CH₂)₂—,
—CF₂—CON(CH₃)—(CH₂)₃—,
—CH₂—CONH—,
—CH₂—CONH—CH₂—,
—CH₂—CONH—(CH₂)₂—,
—CH₂—CONH—(CH₂)₃—,
—CF₂—CH₂—CONH—,
—CF₂—CH₂—CONH—CH₂—,
—CF₂—CH₂—CONH—(CH₂)₂—,
—CF₂—CH₂—CONH—(CH₂)₃—,
—CONH—C₆H₄—,
—CON(CH₃)—C₆H₄—,
—CH₂—CON(CH₃)—CH₂—,
—CH₂—CON(CH₃)—(CH₂)₂—,
—CH₂—CON(CH₃)—(CH₂)₃—,
—CON(CH₃)—C₆H₄—,
—CF₂—CONH—C₆H₄—,
—CF₂—CON(CH₃)—C₆H₄—,
—CF₂—CH₂—CON(CH₃)—CH₂—,
—CF₂—CH₂—CON(CH₃)—(CH₂)₂—,
—CF₂—CH₂—CON(CH₃)—(CH₂)₃—,
—CF₂—CON(CH₃)—C₆H₄—,
or the like.

Compounds represented by above Formulas (A1) and (A2) can be produced by a known method, for example, the method described in Patent Document 1 or an improved method thereof.

### Formulas (B1) and (B2):

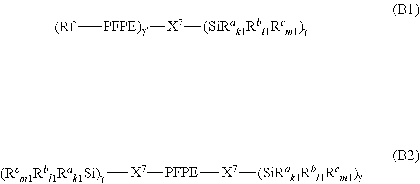

In above Formulas (B1) and (B2), Rf and PFPE have same meanings as those described for above Formulas (A1) and (A2).

In the above formula, X⁷ independently represents a single bond or a 2 to 10 valent organic group. In the compounds represented by Formulas (B1) and (B2), the X⁷ is understood to be a linker which links a perfluoropolyether moiety which mainly provides water repellency, surface slidability, or the like (Rf-PFPE moiety or -PFPE-moiety) and a silane moiety which provides a bonding ability to a base material (specifically, —SiR^{a}ₖ₁R^{b}ₗ₁R^{c}ₘ₁ group). Therefore, the X⁷ may be any organic group as long as the compounds represented by Formulas (B1) and (B2) can be stably present.

In the above formula, γ is an integer of 1 to 9, and γ′ is an integer of 1 to 9. These γ and γ′ are determined according to a valence of X⁷, and in Formula (B1), a sum of γ and γ′ is the same as the valence of X⁷. For example, when X⁷ is a 10 valent organic group, the sum of γ and γ′ is 10, for example, γ may be 9 and γ′ may be 1, γ may be 5 and γ′ may be 5, or γ may be 1 and γ′ may be 9. In addition, when X⁷ is a divalent organic group, γ and γ′ are 1. In Formula (B2), γ is a value obtained by subtracting 1 from a valence value of X⁷.

The X⁷ is preferably an organic group having a valency of 2 to 7, more preferably 2 to 4, and still more preferably 2.

In one aspect, X⁷ is a 2 to 4 valent organic group, y is 1 to 3, and γ′ is 1.

In another aspect, X⁷ is a divalent organic group, γ is 1, and γ′ is 1. In this case, Formulas (B1) and (B2) are represented by following Formulas (B1′) and (B2′).

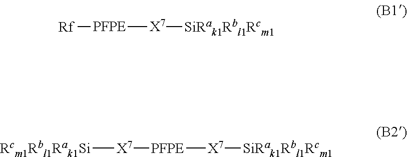

Examples of the X⁷ include, but are not particularly limited to, those described for X⁵.

In the above formula, R^{a}, in each occurrence, independently represents —Z¹—SiR⁷¹ₚ₁R⁷²_{q1}R⁷³ᵣ₁.

In the formula, Z¹, in each occurrence, independently represents an oxygen atom or a divalent organic group.

The Z¹ is preferably a divalent organic group, and does not include a group forming a siloxane bond with a Si atom (a Si atom to which R^{a} is bonded) at a terminal of a molecular main chain in Formula (B1) or (B2).

The Z¹ is preferably a C₁₋₆ alkylene group, —(CH₂)_{g}—O—(CH₂)ₕ— (wherein g is an integer of 1 to 6 and h is an integer of 1 to 6) or -phenylene-(CH₂)ᵢ— (wherein i is an integer of 0 to 6), and more preferably a C₁₋₃ alkylene group. These groups may be substituted with one or more substituents selected from, for example, a fluorine atom, a C₁₋₆ alkyl group, a C₂₋₆ alkenyl group, and a C₂₋₆ alkynyl group.

In the formula, R⁷¹, in each occurrence, independently represents R^{a′}. R^{a′} has a same meaning as R^{a}.

In R^{a}, a number of at least one Si atom linearly linked via a Z¹ group is at most 5. That is, in the R^{a}, when at least one R⁷¹ is present, two or more Si atoms linearly linked via the Z¹ group are present in the R^{a}, but the number of at least one Si atom linearly linked via the Z¹ group in this manner is at most 5. Note that the “number of at least one Si atom linearly linked via the Z¹ group in the R^{a}” is equal to a number of at least one repetition of —Z¹—Si— linearly linked in R^{a}.

For example, an example in which Si atoms are linked via a Z¹ group (hereinafter simply referred to as “Z”) in R^{a} will be described below.

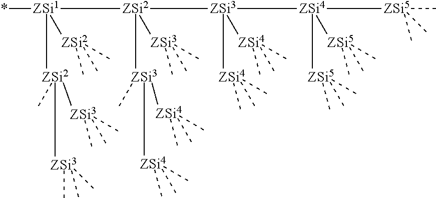

In the above formula, * means a site which is bonded to Si of a main chain, and . . . means that a predetermined group other than ZSi is bonded, that is, when all three bonds of a Si atom are . . . , it means an end point of ZSi repetition. In addition, a superscript number of Si means a number of occurrences of Si linearly linked via the Z group, the number being counted from *. That is, in a chain in which ZSi repetition is completed in Si², the “number of at least one Si atom linearly linked via the Z¹ group in the R^{a}” is 2, and similarly, in chains in which the ZSi repetition is completed in Si³, Si⁴, and Si⁵, the “number of at least one Si atom linearly linked via the Z¹ group in the R^{a}” is 3, 4, and 5, respectively. Note that, as is clear from the above formula, a plurality of ZSi chains are present in the R^{a}, but they do not need to have a same length, and may each have any length.

In a preferred aspect, as shown below, the “number of at least one Si atom linearly linked via the Z¹ group in the R^{a}” is 1 (left formula) or 2 (right formula) in all chains.

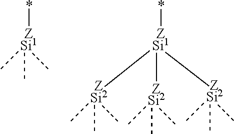

In one aspect, the number of at least one Si atom linearly linked via the Z group in the R^{a} is 1 or 2, preferably 1.

In the formula, R⁷², in each occurrence, independently represents a hydroxyl group or a hydrolyzable group.

The “hydrolyzable group” as used in the present specification means a group capable of undergoing hydrolysis reaction. Examples of the hydrolyzable group include —OR, —OCOR, —O—N═C(R)₂, —N(R)₂, —NHR, halogen (in these Formulas, R represents a substituted or unsubstituted alkyl group having 1 to 4 carbon atoms), or the like, and is preferably —OR (alkoxy group). Examples of R include an unsubstituted alkyl group such as a methyl group, an ethyl group, a propyl group, an isopropyl group, a n-butyl group, or an isobutyl group; and a substituted alkyl group such as a chloromethyl group. Among them, an alkyl group, particularly an unsubstituted alkyl group is preferable, and a methyl group or an ethyl group is more preferable. The hydroxyl group is not particularly limited, but may be generated by hydrolysis of the hydrolyzable group.

Preferably, R⁷² is —OR (wherein R represents a substituted or unsubstituted C₁₋₃ alkyl group, more preferably a methyl group).

In the formula, R⁷³, in each occurrence, independently represents a hydrogen atom or a lower alkyl group. The lower alkyl group is preferably an alkyl group having 1 to 20 carbon atoms, more preferably an alkyl group having 1 to 6 carbon atoms, and still more preferably a methyl group.

In the formula, p1 is, in each occurrence, independently an integer of 0 to 3; q1 is, in each occurrence, independently an integer of 0 to 3; and r1 is, in each occurrence, independently an integer of 0 to 3. Here, a sum of p1, q1, and r1 is 3.

In a preferred aspect, R^{a′} (when R^{a′} is not present, R^{a}) at a terminal in R^{a}, the q1 is preferably 2 or more, for example, 2 or 3, more preferably 3.

In a preferred aspect, at least one of termini of R^{a} may be —Si(—Z¹—SiR⁷²_{q}R⁷³ᵣ)₂ or —Si(—Z¹—SiR⁷²_{q}R⁷³ᵣ)₃, preferably —Si(—Z¹—SiR⁷²_{q}R⁷³ᵣ)₃. In the formula, a unit of (—Z¹—SiR⁷²_{q}R⁷³ᵣ) is preferably (—Z¹—SiR⁷²₃). In a further preferred aspect, the termini of R^{a} may all be —Si(—Z¹—SiR⁷²_{q}R⁷³ᵣ)₃, preferably —Si(—Z¹—SiR⁷²₃)₃.

In above Formulas (B1) and (B2), at least one R⁷² is present.

In the above formula, R^{b}, in each occurrence, independently represents a hydroxyl group or a hydrolyzable group.

The R^{b} is preferably a hydroxyl group, —OR, —OCOR, —O—N═C(R)₂, —N(R)₂, —NHR, or halogen (in these Formulas, R represents a substituted or unsubstituted alkyl group having 1 to 4 carbon atoms), and is preferably —OR. R includes an unsubstituted alkyl group such as a methyl group, an ethyl group, a propyl group, an isopropyl group, a n-butyl group, or an isobutyl group; and a substituted alkyl group such as a chloromethyl group. Among them, an alkyl group, particularly an unsubstituted alkyl group is preferable, and a methyl group or an ethyl group is more preferable. The hydroxyl group is not particularly limited, but may be generated by hydrolysis of the hydrolyzable group. More preferably, R^{b} is —OR (wherein R represents a substituted or unsubstituted C₁₋₃ alkyl group, more preferably a methyl group).

In the above formula, R^{c}, in each occurrence, independently represents a hydrogen atom or a lower alkyl group. The lower alkyl group is preferably an alkyl group having 1 to 20 carbon atoms, more preferably an alkyl group having 1 to 6 carbon atoms, and still more preferably a methyl group.

In the formula, k1 is, in each occurrence, independently an integer of 0 to 3; l1 is, in each occurrence, independently an integer of 0 to 3; and m1 is, in each occurrence, independently an integer of 0 to 3. Here, a sum of k1, l1, and m1 is 3.

In a preferred aspect, k1 is, in each occurrence, independently an integer of 1 to 3; l1 is, in each occurrence, independently an integer of 0 to 2; and m1 is, in each occurrence, independently an integer of 0 to 2.

The compounds represented by Formulas (B1) and (B2) can be obtained, for example, by using, as a raw material, a perfluoropolyether derivative corresponding to a Rf-PFPE-moiety, introducing a hydroxyl group at its terminal, then introducing a group having an unsaturated bond at the terminal, reacting the group having an unsaturated bond with a silyl derivative having a halogen atom, further introducing the hydroxyl group at the terminal to the silyl group, and reacting the introduced group having an unsaturated bond with the silyl derivative.

### Formulas (C1) and (C2):

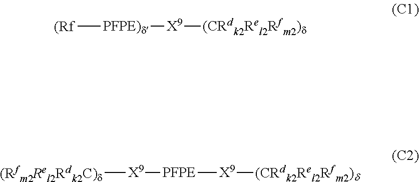

In above Formulas (C1) and (C2), Rf and PFPE have the same meanings as those described for above Formulas (A1) and (A2).

In the above formula, X⁹ independently represents a single bond or a 2 to 10 valent organic group. In the compounds represented by Formulas (C1) and (C2), the X is understood to be a linker which links a perfluoropolyether moiety which mainly provides water repellency, surface slidability, or the like (that is, a Rf-PFPE moiety or a -PFPE-moiety) and a moiety which provides a bonding ability to a base material (that is, a group parenthesized with δ). Therefore, the X may be any organic group as long as the compounds represented by Formulas (C1) and (C2) can be stably present.

In the above formula, δ is an integer of 1 to 9 and δ′ is an integer of 1 to 9. These δ and δ′ may vary depending on a valence of X. In Formula (C1), a sum of δ and δ′ is the same as the valence of X. For example, when X is a 10 valent organic group, the sum of δ and δ′ is 10, for example, δ may be 9 and δ′ may be 1, δ may be 5 and δ′ may be 5, or δ may be 1 and δ′ may be 9. In addition, when X⁹ is a divalent organic group, δ and δ′ are 1. In Formula (C2), δ is a value obtained by subtracting 1 from a valence of X⁹.

The X⁹ is preferably an organic group having a valency of 2 to 7, more preferably 2 to 4, and still more preferably 2.

In one aspect, X⁹ is a 2 to 4 valent organic group, δ is 1 to 3, and δ′ is 1.

In another aspect, X⁹ is a divalent organic group, δ is 1, and δ′ is 1. In this case, Formulas (C1) and (C2) are represented by following Formulas (C1′) and (C2′).

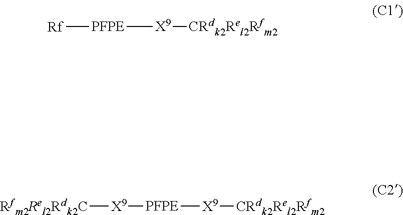

Examples of the X⁹ include, but are not particularly limited to, those described for X⁵.

In the above formula, R^{d}, in each occurrence, independently represents —Z²—CR⁸¹ₚ₂R⁸²_{q2}R⁸³ᵣ₂.

In the formula, Z², in each occurrence, independently represents an oxygen atom or a divalent organic group.

The Z² is preferably a C₁₋₆ alkylene group, —(CH₂)_{g}—O—(CH₂)ₕ— (wherein g is an integer of 0 to 6, for example, an integer of 1 to 6, and h is an integer of 0 to 6, for example, an integer of 1 to 6), or -phenylene-(CH₂)ᵢ— (wherein i is an integer of 0 to 6), and more preferably a C₁₋₃ alkylene group. These groups may be substituted with one or more substituents selected from, for example, a fluorine atom, a C₁₋₆ alkyl group, a C₂₋₆ alkenyl group, and a C₂₋₆ alkynyl group.

In the formula, R⁸¹, in each occurrence, independently represents R^{d′}. R^{d′} has the same meaning as R^{d}.

In R^{d}, a number of at least one C atom linearly linked via a Z² group is at most 5. That is, in the R^{d}, when at least one R⁸¹ is present, two or more C atoms linearly linked via the Z² group are present in the R^{d}, but the number of at least one C atom linearly linked via the Z² group in this manner is at most 5. Note that the “number of at least one C atom linearly linked via the Z² group in the R^{d}” is equal to a number of at least one repetition of —Z²—C— linearly linked in R^{d}. This is similar to the description regarding R^{a} in Formulas (B1) and (B2).

In a preferred aspect, the “number of at least one C atom linearly linked via the Z² group in the R^{d}” is 1 (left formula) or 2 (right formula) in all chains.

In one aspect, the number of at least one C atom linearly linked via the Z² group in the R^{d} is 1 or 2, preferably 1.

In the formula, R⁸² represents —Y—SiR⁸⁵ₙ₂R⁸⁶₃₋₂ₙ.

Y, in each occurrence, independently represents a divalent organic group.

In a preferred aspect, the Y is a C₁₋₆ alkylene group, —(CH₂)_{g′}—O—(CH₂)_{h′}— (wherein g′ is an integer of 0 to 6, for example, an integer of 1 to 6, and h′ is an integer of 0 to 6, for example, an integer of 1 to 6), or -phenylene-(CH₂)_{i′}— (where i′ is an integer of 0 to 6). These groups may be substituted with one or more substituents selected from, for example, a fluorine atom, a C₁₋₆ alkyl group, a C₂₋₆ alkenyl group, and a C₂₋₆ alkynyl group.

In one aspect, the Y may be a C₁₋₆ alkylene group, —O—(CH₂)_{h′}— or -phenylene-(CH₂)_{i′}—. When the Y is the group as described above, light resistance, particularly ultraviolet resistance, can be improved.

The R⁸⁵, in each occurrence, independently represents a hydroxyl group or a hydrolyzable group.

The “hydrolyzable group” as used in the present specification means a group capable of undergoing hydrolysis reaction. Examples of the hydrolyzable group include —OR, —OCOR, —O—N═C(R)₂, —N(R)₂, —NHR, halogen (in these Formulas, R represents a substituted or unsubstituted alkyl group having 1 to 4 carbon atoms), or the like, and is preferably —OR (alkoxy group). Examples of R include unsubstituted alkyl groups such as a methyl group, an ethyl group, a propyl group, an isopropyl group, a n-butyl group, or an isobutyl group; and a substituted alkyl group such as a chloromethyl group. Among them, an alkyl group, particularly an unsubstituted alkyl group is preferable, and a methyl group or an ethyl group is more preferable. The hydroxyl group is not particularly limited, but may be generated by hydrolysis of the hydrolyzable group.

Preferably, R⁸⁵ is —OR (wherein R represents a substituted or unsubstituted C₁₋₃ alkyl group, more preferably an ethyl group or a methyl group, particularly, a methyl group).

The R⁸⁶, in each occurrence, independently represents a hydrogen atom or a lower alkyl group. The lower alkyl group is preferably an alkyl group having 1 to 20 carbon atoms, more preferably an alkyl group having 1 to 6 carbon atoms, and still more preferably a methyl group.

n2 represents, independently for each (—Y—SiR⁸⁵ₙ₂R⁸⁶₃₋ₙ₂) unit, an integer of 0 to 3, preferably an integer of 1 to 3, more preferably 2 or 3, still more preferably 3.

The R⁸³, in each occurrence, independently represents a hydrogen atom, a hydroxyl group, or a lower alkyl group. The lower alkyl group is preferably an alkyl group having 1 to 20 carbon atoms, more preferably an alkyl group having 1 to 6 carbon atoms, and still more preferably a methyl group. In one aspect, R⁸³, in each occurrence, independently represents a hydrogen atom or a lower alkyl group.

In the formula, p2 is, in each occurrence, independently an integer of 0 to 3; q2 is, in each occurrence, independently an integer of 0 to 3; and r2 is, in each occurrence, independently an integer of 0 to 3. Here, a sum of p2, q2, and r2 is 3.

In a preferred aspect, R^{d′} (when R^{d′} is not present, R^{d}) at a terminal in R^{d}, the q2 is preferably 2 or more, for example, 2 or 3, more preferably 3.

In a preferred aspect, at least one of termini of R^{d} may be —C(—Y—SiR⁸⁵_{q2}R⁸⁶ᵣ₂)₂ or —C(—Y—SiR⁸⁵_{q2}R⁸⁶ᵣ₂)₃, preferably —C(—Y—SiR⁸⁵_{q2}R⁸⁶ᵣ₂)₃. In the formula, a unit of (—Y—SiR⁸⁵_{q2}R⁸⁶ᵣ₂) is preferably (—Y—SiR⁸⁵₃). In a further preferred aspect, the termini of R^{d} may all be —C(—Y—SiR⁸⁵_{q2}R⁸⁶ᵣ₂)₃, preferably —C(—Y—SiR⁸⁵₃)₃.

In the above formula, R^{e}, in each occurrence, independently represents —Y—SiR⁸⁵ₙ₂R⁸⁶₃₋ₙ₂. Here, Y, R⁸⁵, R⁸⁶, and n2 have same meanings as described in the R⁸².

In the above formula, R^{f}, in each occurrence, independently represents a hydrogen atom, a hydroxyl group, or a lower alkyl group. The lower alkyl group is preferably an alkyl group having 1 to 20 carbon atoms, more preferably an alkyl group having 1 to 6 carbon atoms, and still more preferably a methyl group. In one aspect, Rf, in each occurrence, independently represents a hydrogen atom or a lower alkyl group.

In the formula, k2 is, in each occurrence, independently an integer of 0 to 3; l2 is, in each occurrence, independently an integer of 0 to 3; and m2 is, in each occurrence, independently an integer of 0 to 3. Here, a sum of k2, l2, and m2 is 3.

In one aspect, at least one k2 is 2 or 3, preferably 3.

In one aspect, k2 is 2 or 3, preferably 3.

In one aspect, l2 is 2 or 3, preferably 3.

In above Formulas (C1) and (C2), at least one q2 is 2 or 3, or at least one l is 2 or 3. That is, at least two —Y—SiR⁸⁵ₙ₂R⁸⁶₃₋ₙ₂ groups are present in the formula.

A perfluoro(poly)ether group-containing silane compound represented by Formula (C1) or (C2) can be produced by combining known methods. For example, a compound represented by Formula (C1′) in which X is divalent can be produced as follows, but is not limited thereto.

In one aspect, Rf′ in each aspect described above is a single bond in Formulas (A1), (B1), and (C1), and in Formulas (A2), (B2), and (C2), is (C_{l′}F_{2l′}) at X⁵ located on a left side of PFPE, and is (C_{l′}F_{2l′}) at X⁵ located on a right side of PFPE.

In one aspect, Rf′ in each aspect described above may be a single bond.

A perfluoro(poly)ether group-containing silane compound represented by Formulas (A1), (A2), (B1), (B2), (C1) and (C2) is not particularly limited, but may have a number-average molecular weight of 5×10² to 1×10⁵. The number-average molecular weight may be preferably 2,000 to 30,000, more preferably 3,000 to 10,000, and still more preferably 3,000 to 8,000. The “number-average molecular weight” is measured by GPC (gel permeation chromatography) analysis.

In the surface treatment agent of the present disclosure, a total of compounds represented by Formulas (A1), (B1), and (C1) (hereinafter, also referred to as a “single-ended compound”) and compounds respectively represented by Formulas (A2), (B2) or (C2) (hereinafter, also referred to as a “double-ended compound”) preferably contains 0.1 mol % or more and 35 mol % or less of the double-ended compound. A lower limit of a content of the double-ended compound with respect to the total of the single-ended compound and the double-ended compound may be preferably 0.1 mol %, more preferably 0.2 mol %, still more preferably 0.5 mol %, still more preferably 1 mol %, particularly preferably 2 mol %, and particularly 5 mol %. An upper limit of the content of the double-ended compound with respect to the total of the single-ended compound and the double-ended compound may be preferably 35 mol %, more preferably 30 mol %, still more preferably 20 mol %, and still more preferably 15 mol % or 10 mol %. The content of the double-ended compound with respect to the total of the single-ended compound and the double-ended compound is preferably 0.1 mol % or more and 30 mol % or less, more preferably 0.1 mol % or more and 20 mol % or less, still more preferably 0.2 mol % or more and 10 mol % or less, still more preferably 0.5 mol % or more and 10 mol % or less, particularly preferably 1 mol % or more and 10 mol % or less, for example, 2 mol % or more and 10 mol % or less, or 5 mol % or more and 10 mol % or less. When the content of the double-ended compound is in such a range, friction durability can be further improved.

Other examples of the perfluoroalkyl group-containing silane compound include following (1) and (2) described in WO 2020/019653 A.

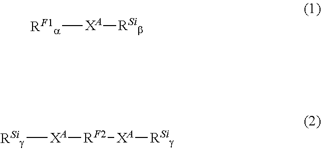

R^{F1} is, in each occurrence, independently Rf¹—R^{F}—O_{q}—;
R^{F2} is —Rf²ₚ—R^{F}—O_{q}—;
Rf¹ is, in each occurrence, independently a C₁₋₁₆ alkyl group which may be substituted with one or more fluorine atoms;
Rf² is a C₁₋₆ alkylene group which may be substituted with one or more fluorine atoms;
R^{F} is, in each occurrence, independently a divalent fluoropolyether group;
p is 0 or 1;
q is, in each occurrence, independently 0 or 1;
R^{Si} is, in each occurrence, independently a monovalent group containing a Si atom to which a hydroxyl group, a hydrolyzable group, a hydrogen atom, or a monovalent organic group is bonded;
at least one R^{Si} is a monovalent group containing a Si atom to which a hydroxyl group or a hydrolyzable group is bonded;
X^{A} is independently a single bond or a 2 to 10 valent organic group;
α is an integer of 1 to 9;
β is an integer of 1 to 9; and
γ is each independently an integer of 1 to 9.

As the isocyanuric skeleton-containing silane compound, for example, a compound having following isocyanuric skeleton described in WO2018/056413 can be used.

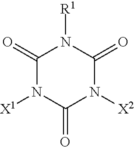

(wherein R¹ represents a monovalent organic group containing a polyether chain, X¹ and X² independently represent a monovalent group, and the polyether chain is a chain represented by a formula: —(OC₆F₁₂)ₘ₁₁—(OC₅F₁₀)ₘ₁₂—(OC₄F₅)ₘ₁₃—(OC₃X¹⁰₆)ₘ₁₄—(OC₂F₄)ₘ₁₅—(OCF₂)ₘ₁₆— (wherein m11, m12, m13, m14, m15 and m16 are independently 0 or an integer of 1 or more, X¹⁰ is independently H, F or Cl, and a sequence of each repeating unit is arbitrary)).

The antifouling layer 130 may be formed on irregularities by using, with a fluorine-containing silane compound, a vapor deposition process such as PVD such as vacuum deposition, sputtering, or resistance heating vapor deposition, or CVD.

Alternatively, the antifouling layer 130 may be formed by dissolving a fluorine-containing silane compound in an organic solvent, applying the solution to irregularities, and drying the solution. Examples of the organic solvent include acetone, methyl ethyl ketone, methyl amyl ketone, ethyl acetate, propylene glycol, propylene glycol monomethyl ether, propylene glycol monomethyl ether acetate (PGMEA), dipropylene glycol, dipropylene glycol monomethyl ether, dipropylene glycol dimethyl ether, dipropylene glycol monomethyl ether acetate, dipropylene glycol diacetate, tripropylene glycol, 3-methoxybutyl acetate (MBA), 1,3-butylene glycol diacetate, cyclohexanol acetate, dimethylformamide, dimethyl sulfoxide, methyl cellosolve, cellosolve acetate, butyl cellosolve, butyl carbitol, carbitol acetate, ethyl lactate, isopropyl alcohol, methanol, ethanol, chloroform, HFC141b, HCHC225, hydrofluoroether, pentane, hexane, heptane, octane, cyclohexane, benzene, toluene, xylene, petroleum ether, tetrahydrofuran, 1,4-dioxane, methyl isobutyl ketone, butyl acetate, 1,1,2,2-tetrachloroethane, 1,1,1-trichloroethane, trichloroethylene, perchloroethylene, tetrachlorodifluoroethane, trichlorotrifluoroethane, or the like, and one or more thereof may be selected and used.

As an application method, application may be performed by various coating methods such as dip coating, spin coating, flow coating, spray coating, roll coating, and gravure coating, or printing methods such as letterpress printing and inkjet printing.

Drying may be performed under a condition where the organic solvent evaporates to form a solid film of the antifouling layer 130. For example, heating may be performed at 100 to 200° C. for 1 to 60 minutes. Note that since condensation reaction itself proceeds even at a low temperature, drying may be performed under a milder condition than this condition (more than 60 minutes at a temperature of less than 100° C.). For example, drying may be performed by leaving at room temperature for a long time.

In addition to the fluorine-containing silane compound, a monomer, an oligomer, a polymer, and other additives (a catalyst, a surfactant, a polymerization inhibitor, a sensitizer, or the like) may be used to form the antifouling layer 130.

For example, when an isocyanuric skeleton-containing silane compound is used as the fluorine-containing silane compound, in addition to this,
(A) polymerizable coating agent monomers such as monofunctional and/or multifunctional acrylates and methacrylates (hereinafter, acrylates and methacrylates are also collectively referred to as “(meth)acrylates”), monofunctional and/or multifunctional urethane (meth)acrylates, or monofunctional and/or multifunctional epoxy (meth)acrylates, or
(B) (b-1) thermosetting resins such as acrylic polymers, polycarbonate-based polymers, polyester-based polymers, polyamide-based polymers, polyimide-based polymers, polyethersulfone-based polymers, cyclic polyolefin-based polymers, fluorine-containing polyolefin-based polymers (such as PTFE), or fluorine-containing cyclic amorphous polymers (such as CYTOP (registered trademark), or TEFLON (registered trademark) AF), and (b-2) curable monomers such as urethane (meth)acrylates, epoxy (meth)acrylates, polyester (meth)acrylates, polyether (meth)acrylates, silicon (meth)acrylates, or (meth)acrylate monomers may be used.

When a perfluoroalkyl group-containing silane compound is used as the fluorine-containing silane compound, the antifouling layer 130 may be formed by further using a fluoroalkylsilane oligomer mixture in addition to the perfluoroalkyl group-containing silane compound.

The fluoroalkylsilane oligomer mixture may contain a partial hydrolysis condensate of a fluoroalkylsilane compound represented by following Formula (II).

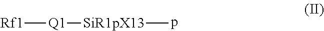

(wherein:
Rf1 is ClF2l+1,
l is an integer of 1 to 10,
Q1 is a single bond or a divalent hydrocarbon group having 1 to 6 carbon atoms,
R1 independently represents a monovalent hydrocarbon group having 1 to 6 carbon atoms,
X1 is independently a hydroxyl group or a hydrolyzable group,
p is an integer of 0 to 2)
In Formula (II), R^{f1} is CₗF₂ₗ₊₁, l is an integer of 1 to 10, preferably an integer of 1 to 8, more preferably an integer of 1 to 6, for example, an integer of 2 to 6 or an integer of 3 to 6.

In Formula (II), Q¹ is a single bond or a divalent hydrocarbon group having 1 to 6 carbon atoms, and examples of the hydrocarbon group include a linear or branched alkylene group, a group having an amide group or an etheric oxygen atom between carbon atoms of the linear or branched alkylene group having 2 to 6 carbon atoms, or the like. Among them, in terms of excellent weather resistance, a linear alkylene group having 1 to 6 carbon atoms: —(CH₂)ₜ— (where t is an integer of 1 to 6) is preferable, and —(CH₂)₂—, —(CH₂)₃—, or —(CH₂)₄— is more preferable, and —(CH₂)₂— is particularly preferable.

In Formula (II), R¹ is a monovalent hydrocarbon group having 1 to 6 carbon atoms, and examples thereof include a linear or branched alkyl group. Among them, in terms of availability, a linear or branched alkyl group having 1 to 4 carbon atoms is preferable, and a methyl group or an ethyl group is more preferable. When a plurality of R¹ groups are present, the R¹ groups may be identical or different, but are preferably identical in terms of availability.

In Formula (II), X¹ represents a hydroxyl group or a hydrolyzable group. Here, the “hydrolyzable group” as used in the present specification means a group that can be desorbed from a main skeleton of a compound by hydrolysis reaction. Examples of the hydrolyzable group include —OR, —OCOR, —O—N═CR₂, —NR₂, —NHR, halogen (in these Formulas, R represents a substituted or unsubstituted alkyl group having 1 to 4 carbon atoms), or the like, and is preferably —OR (that is, an alkoxy group). Examples of R include unsubstituted alkyl groups such as a methyl group, an ethyl group, a propyl group, an isopropyl group, a n-butyl group, or an isobutyl group; and a substituted alkyl group such as a chloromethyl group. Among them, an alkyl group, particularly an unsubstituted alkyl group is preferable, and a methyl group or an ethyl group is more preferable. The hydroxyl group is not particularly limited, but may be generated by hydrolysis of the hydrolyzable group.

When X¹ is a chlorine atom, reactivity is high, and the hydrolysis reaction sufficiently proceeds without adding an acid catalyst. Depending on an application, a compound in which X¹ is a chlorine atom is preferably used.

In Formula (II), p is an integer of 0 to 2, and is preferably 0 or 1, more preferably 0, in terms of excellent adhesion and durability.

Examples of the compound represented by Formula (II) include following compounds. In the formula, examples and preferred aspects of l, t, X¹, R¹ are as described above.

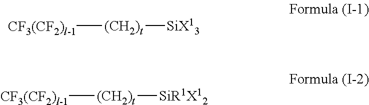

The fluoroalkylsilane compound represented by Formula (II) may be used singly or in combination of two or more kinds thereof. The fluoroalkylsilane compound represented by Formula (II) can be produced by a general production method, and is commercially available.

The fluoroalkylsilane oligomer is obtained by hydrolyzing (SiX¹) moieties of two or more fluoroalkylsilane compounds represented by Formula (II) and condensing them with each other. The fluoroalkylsilane oligomer may usually be a mixture containing mainly oligomers with a degree of polymerization of 2 to 14.

A degree of oligomerization/condensation can be measured by ²⁹Si-NMR, and is indicated by integral values of T0 species (40 to 48 ppm of ²⁹Si-NMR), T1 species (48 to 54 ppm), T2 species (54 to 63 ppm), and T3 species (63 to 75 ppm), respectively. A ²⁹Si-NMR of a fluoroalkylene oligomer mixture indicates 0 to 10%, more preferably 0 to 5%, still more preferably 0 to 3% of T0 species (40 to 48 ppm), 0 to 40%, more preferably 1 to 30%, still more preferably 10 to 25% of T1 species (48 to 54 ppm), and 20 to 80%, more preferably 25 to 75%, still more preferably 30 to 70% of T2 species (54 to 63 ppm). Note that “Tatsuya Miyazaki and 2 others, “Structure analysis of silicon-containing materials by ²⁹Si NMR method”, (online), Asahi Glass Research Report 66 (2016), p. 32 to 36, the Internet <URL: https://www.agc.com/innovation/library/pdf/66-07.pdf>” describes descriptions of T0, T1, T2, and T3.

An oligomer is formed by hydrolysis of the compound represented by Formula (II). The oligomer may be formed by hydrolysis of same or different compounds represented by Formula (II). Hydrolysis reaction between the compound represented by Formula (II) and water can be performed both in presence and absence of a catalyst. A suitable catalysts include, but are not particularly limited to, an acid catalyst, an alkali catalyst, an organic amine catalyst, or a metal catalyst. In one specific example, the catalyst is selected from hydrochloric acid, nitric acid, acetic acid, sulfuric acid, phosphoric acid, sulfonic acid, methanesulfonic acid, p-toluenesulfonic acid, sodium hydroxide, potassium hydroxide, ammonia, triethylamine, titanium isopropoxide, or dibutyltin dilaurate. It is understood that water can be provided as a part of an aqueous catalyst composition.

The degree of oligomerization (based on ²⁹Si-NMR analysis) and/or oligomer size (based on number-average molecular weight) can be adjusted by adjusting an amount of water in a reaction system, by selecting a suitable catalyst, and/or by selecting a suitable reaction condition. In particular, a molar ratio of water to silicon is controlled the provision of oligomers according to the present disclosure. In one specific example, the molar ratio of water to silicon (water:silicon) may be equal to or less than about 2.5:1, equal to or less than about 2:1, equal to or less than about 1.5:1, equal to or less than about 1.25:1, equal to or less than about 1:1, equal to or less than about 0.75:1, or equal to or less than about 0.5:1. In one specific example, the molar ratio of water to silicon (water:silicon) may be 0.5:1 to 2.5:1, 0.75:1 to 2:1, 1:1 to 1.5:1, or 1:1 to 1.25:1. Note that even in a range other than the above ranges, another range obtained by combining an upper limit and a lower limit of each of the above ranges can be used.

The fluoroalkylsilane oligomer can be subjected to structural analysis and composition analysis by ¹H-NMR, ²⁹Si-NMR, GC (gas chromatography), and LC (liquid chromatography) analysis, and a composition and ratio of a mixture containing oligomers with a degree of polymerization of 2 to 14, a ratio and residual ratio of hydrolyzable groups, a degree of condensation, or the like can be measured.

The number-average molecular weight of the fluoroalkylsilane oligomer mixture may be preferably 300 or more, preferably 400 or more, more preferably 500 or more, and still more preferably 800 or more.

The number-average molecular weight of the fluoroalkylsilane oligomer mixture may be preferably 4500 or less, more preferably 4000 or less, still more preferably 3500 or less, and still more preferably 3000 or less.

Note that in the present invention, the “number-average molecular weight” is measured by GPC (gel permeation chromatography) analysis.

In the fluoroalkylsilane oligomer mixture, a content ratio (OCH₃/Si, molar ratio) of methoxy groups (OCH₃) to silicon (Si) may be preferably 1.5 or more, more preferably 2.0 or more, and still more preferably 2.2 or more. By setting the ratio to 1.5 or more, friction durability is further improved. In addition, the content ratio of methoxy groups to silicon may be preferably 2.8 or less, more preferably 2.7 or less, and still more preferably 2.5 or less. By setting the ratio to 2.8 or less, abrasion durability is further improved.

The content ratio of methoxy groups to silicon can be measured using ²⁹Si-NMR.

The fluoroalkylsilane oligomer mixture may be preferably 20 mass % or less, and more preferably 10 mass % or less with respect to a total amount of the fluoroalkylsilane oligomer mixture and the perfluoroalkyl group-containing silane compound.

The fluoroalkylsilane oligomer mixture may be preferably 0.1 mass % or more, and more preferably 0.5 mass % or more with respect to the total amount of the fluoroalkylsilane oligomer mixture and the perfluoroalkyl group-containing silane compound.

As described above, according to the present embodiment, the antifouling layer 130 is formed on irregularities (the irregularities of the base material 110 or the irregularity forming layer 120) by executing S100 to S200. Accordingly, the antifouling layer 130 is firmly bonded to the irregularities, so that the abrasion resistance and durability of the antifouling layer 130 can be improved.

### EXAMPLES

Hereinafter, examples of the present embodiment will be described with reference to examples. Following compound X was used.

### Compound X:

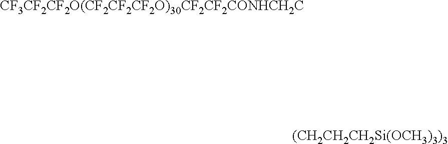

Compound X was dissolved in hydrofluoroether (3M Japan Ltd., Novec HFE7200) so as to have a concentration of 20 mass %, thereby obtaining a surface treatment agent Y.

### Example 1

On a base material (chemically strengthened glass (“Gorilla” glass manufactured by Corning Incorporated, thickness: 0.7 mm)), AS4700F (manufactured by Momentive Performance Materials Inc.) was applied as a resin composition for irregularity formation, and heated and dried to obtain a member A.

The dried resin composition for irregularity formation of the member A was irradiated with a Xe excimer lamp to form the irregularity forming layer 120, thereby obtaining a member B.

The surface treatment agent Y was vacuum-deposited on a side of the dried resin composition for irregularity formation of the member A. A processing condition of the vacuum deposition was a pressure of 3.0×10⁻³ Pa. A treatment amount per sheet of chemically strengthened glass was 2 mg of the surface treatment agent Y (that is, containing 0.4 mg of the compound X), which was deposited to form the antifouling layer 130, thereby obtaining a member C.

The surface treatment agent Y was vacuum-deposited on a side of the irregularity forming layer 120 of the member B. A processing condition of the vacuum deposition was a pressure of 3.0×10⁻³ Pa. A treatment amount per sheet of chemically strengthened glass was 2 mg of the surface treatment agent Y (that is, containing 0.4 mg of the compound X), which was deposited to form the antifouling layer 130, thereby obtaining a member D.

### (Friction Durability Test)

A static contact angle of water was measured for surface layers of the member C and the member D formed as described above. The static contact angle of water was measured with 1 μL of water by using a contact angle measuring device (manufactured by Kyowa Interface Science Co., Ltd).

First, as an initial evaluation, the static contact angles of water of the member C and the member D were measured in a state where their surfaces had not yet been touched (friction count: 0).

Thereafter, steel wool friction durability was evaluated as a friction durability evaluation. Specifically, a base material on which a surface treatment layer was formed was horizontally arranged, and steel wool (grade #0000, dimensions 5 mm×10 mm×10 mm) was brought into contact with an exposed upper surface of the surface treatment layer, a load of 1,000 gf was applied thereon, and then the steel wool was reciprocated at a speed of 140 mm/sec in a state where the load was applied. The static contact angle (degree) of water was measured every 1,000 reciprocations. Note that the evaluation was performed up to 10,000 reciprocations or until a measured value of the contact angle was less than 80°. Results are shown in Table 2 (“-” indicates no measurement).

TABLE 1

| FRICTION | | |
|---|---|---|
| COUNT | MEMBER C | MEMBER D |
| 0 | 113 | 115 |
| 1000 | 104 | 110 |
| 2000 | 92 | 105 |
| 3000 | 74 | 99 |
| 4000 | — | 92 |
| 5000 | — | 84 |
| 6000 | — | 75 |

Results of measuring the surface states of the members A to D with an atomic force microscope are shown below.

TABLE 2

| | Image | | | | | | Profile | | | |
|---|---|---|---|---|---|---|---|---|---|---|
| | Ra(nm) | RMS(nm) | Rz(nm) | P − V(nm) | S(μm²) | S Ratio | Ra(nm) | Rz(nm) | P − V(nm) | RMS(nm) |
| MEMBER A | 0.652 | 0.939 | 13.9 | 22.1 | 9.03 | 1 | 0.522 | 2.32 | 3.62 | 0.657 |
| MEMBER B | 0.857 | 1.09 | 9.91 | 10.8 | 9.05 | 1.01 | 0.898 | 3.44 | 5.26 | 1.09 |
| MEMBER C | 0.619 | 0.782 | 7.75 | 11 | 9.02 | 1 | 0.474 | 2.07 | 2.73 | 0.581 |
| MEMBER D | 1.4 | 1.75 | 14.5 | 16.7 | 9.32 | 1.04 | 1.17 | 6.62 | 8.55 | 1.47 |

Here, Profile is a numerical value calculated using, as a measurement region, a cross section of a surface based on an analysis image, and Image is a numerical value calculated using, as a measurement region, an entire plane of the surface of the analysis image. R^{a} (nm) is an arithmetic average roughness (which can calculated, for example, by using a calculation formula defined in JIS B0601 or by extending the calculation formula), RMS (nm) is a root mean square roughness, Rz (nm) is a surface roughness (that is, which is a maximum height, and can be calculated by using a calculation formula of a ten-point average roughness Rz defined in JISB0601 or by extending the formula), P−V (nm) is a maximum height difference representing (maximum value−minimum value) of a height z, S (μm²) is obtained by calculating a net surface area of an analysis plane as a sum of vector products of microdivision planes, and S Ratio is a ratio of the net surface area S to a surface area S₀ when the analysis plane is ideally flat.

While the present invention has been described by way of the embodiments, the technical scope of the present invention is not limited to the above-described embodiments. It is apparent to persons skilled in the art that various alterations or improvements can be made to the above-described embodiments. It is also apparent from the scope of the claims that the embodiments added with such alterations or improvements can be included in the technical scope of the invention.

It should be noted that each process of the operations, procedures, steps, stages, and the like performed by a method shown in the claims, specification, or drawings can be executed in any order as long as the order is not indicated by “prior to,” “before,” or the like and as long as a result of a previous process is not used in a later process. Even if the operation flow is described by using phrases such as “first” or “next” for the sake of convenience in the claims, specification, and drawings, it does not necessarily mean that the process must be performed in this order.

### EXPLANATION OF REFERENCES

10: antifouling member;
110: base material;
120: irregularity forming layer; and
130: antifouling layer.

1. An antifouling member, wherein
a surface of one face is provided with irregularities on an order of nanometers, the antifouling member comprising
an antifouling layer which is provided on recesses of the irregularities.

2. The antifouling member according to claim 1, wherein
an average pitch width of protrusions of the irregularities is 5 to 18 nm.

3. The antifouling member according to claim 1, wherein
a surface roughness (Rz) measured on a plane of the irregularities is 9 to 12 nm.

4. The antifouling member according to claim 1, wherein
a surface roughness (Rz) measured in a cross section of the irregularities is 3 to 5 nm.

5. The antifouling member according to claim 1, wherein
a maximum height difference (P−V) measured on a plane of the irregularities is 5 to 15 nm, or a maximum height difference (P−V) measured in a cross section of the irregularities is 4 to 8 nm.

6. The antifouling member according to claim 1, wherein
an arithmetic average roughness (R^{a}) measured on a plane or in a cross section of the irregularities is 0.6 to 2.0 nm.

7. The antifouling member according to claim 1, wherein
a root mean square roughness (RMS) measured on a plane of the irregularities is 0.8 to 2.0 nm, or a root mean square roughness (RMS) measured in a cross section of the irregularities is 0.7 to 3.0 nm.

8. The antifouling member according to claim 1, comprising:
a base material; and
an irregularity forming layer, wherein
the irregularities are formed on a surface of the irregularity forming layer.

9. The antifouling member according to claim 1, comprising
a base material, wherein
the irregularities are formed on a surface of the base material.

10. The antifouling member according to claim 1, wherein
a height, in a normal direction of the one face, of the antifouling layer formed in the recesses does not exceed that of protrusions of the irregularities.

11. The antifouling member according to claim 1, wherein
a contact angle when water comes into contact with a side of the one face is 105 to 120°.

12. The antifouling member according to claim 1, wherein
a pencil hardness on a side of the one face is HB or more.

13. The antifouling member according to claim 1, wherein
the antifouling layer contains a perfluoropolyether-containing silane compound.

14. The antifouling member according to claim 8, wherein
the irregularity forming layer contains a silicone resin.

15. The antifouling member according to claim 14, wherein
the silicone resin includes a Q unit structure and a T unit structure.

16. The antifouling member according to claim 15, wherein
a composition ratio of carbon atoms in recesses of the irregularity forming layer is larger than that in protrusions thereof.

17. The antifouling member according to claim 15, wherein
a molar concentration of a silanol group in recesses of the irregularity forming layer is higher than that in protrusions thereof.

18. A display, wherein at least a part of a display portion is covered with the antifouling member according to claim 1.

19. A touch panel, wherein at least a part of a touch portion is covered with the antifouling member according to claim 1.

20. A sensor, wherein at least a partial surface is covered with the antifouling member according to claim 1.
